(19) United States
(12) Patent Application Publication
(10) Pub. No.: US 2014/0307169 A1
(43) Pub. Date: Oct. 16, 2014

(54) NOISE REDUCTION APPARATUS, DISPLAY APPARATUS, NOISE REDUCTION METHOD, AND NOISE REDUCTION PROGRAM

(71) Applicant: Sharp Kabushiki Kaisha, Osaka-shi, Osaka (JP)

(72) Inventor: Yoshimitsu Murahashi, Osaka-shi (JP)

(21) Appl. No.: 14/357,303

(22) PCT Filed: Nov. 6, 2012
(86) PCT No.: PCT/JP2012/078762

§ 371 Date: May 9, 2014

(30) Foreign Application Priority Data
Nov. 10, 2011 (JP) 2011-246623

(51) Int. Cl. H04N 5/21; H04N 5/14

(52) U.S. Cl. CPC H04N 5/21; H04N 5/147
USPC 348/607

(57) ABSTRACT

A noise reduction apparatus includes a scene change frame detection unit that detects at least one of frames immediately before and immediately after a scene change among frames included in a video signal and a time-difference signal having a time difference from the video signal based on the video signal and the time-difference signal and a noise reduction processing unit that weakens noise reduction of inter-frame noise superimposed between frames for at least one image signal of the at least one frame detected by the scene change frame detection unit.

### TECHNICAL FIELD

The present invention relates to a noise reduction apparatus, display apparatus, noise reduction method, and noise reduction program.

The present application claims priority to Japanese Patent Application No. 2011-246623 filed in Japan on Nov. 10, 2011, the contents of which are incorporated herein by reference.

### BACKGROUND ART

Conventionally, a noise reduction apparatus has reduced noise reduction effects for video when it detects a scene change of video.

For example, PLT 1 describes a cyclic noise reduction apparatus that includes a frame memory that relays an input video signal by one frame, a coefficient generator that generates controllable coefficient K (0≦K≦1), a multiplier that multiplies an input video signal by 1-K, a multiplier that multiplies the video signal, delayed by one frame, that is output from the frame memory by K, and an adder that adds the output signals from the multipliers.

The cyclic noise reduction apparatus stores, in the frame memory, the added signals from the adder and outputs it as a video signal. The cyclic noise reduction apparatus has a detection circuit that detects a scene change in an input video signal as, for example, a change in voice mode so as to set coefficient K to 0 only for one frame when the circuit detects a scene change. This enables the cyclic noise reduction apparatus to reduce noise without generating afterimages even if a scene change occurs in video.

### CITATION LIST

### Patent Literature

PTL 1: Japanese Unexamined Patent Application Publication No. 2000-224444

### SUMMARY OF INVENTION

### Technical Problem

In the cyclic noise reduction apparatus described in PTL 1, a signal obtained by multiplying the processed signal in the previous frame by K is reflected on an output signal. Accordingly, in the cyclic noise reduction apparatus, for example, noise reduction is relaxed during detection of a scene change and a signal with much noise is reflected on the output signal, thereby superimposing noise on an image for a long period of time after a scene change. As a result, the cyclic noise reduction apparatus provides video not easily viewable to audiences.

The present invention addresses the above problem with the object of providing a noise reduction apparatus, display apparatus, noise reduction method, and noise reduction program that can provide video easily viewable to audiences.

### Solution to Problem

(1) A noise reduction apparatus according to an aspect of the present invention includes a scene change frame detection unit that references a video signal and a time-difference signal having a time difference from the video signal and detects at least one of frames immediately before and immediately after a scene change among frames included in the video signal or the time-difference signal and a noise reduction processing unit that weakens noise reduction of inter-frame noise superimposed between frames for an image signal of the at least one of frames detected by the scene change frame detection unit.

(2) In the noise reduction apparatus according to the aspect of the present invention, the scene change frame detection unit detects one of the frames immediately before and immediately after a scene change and the noise reduction processing unit weakens noise reduction of the inter-frame noise for the one of the image signals of the frames immediately before and immediately after a scene change detected by the scene change frame detection unit.

(3) In the noise reduction apparatus according to the aspect of the present invention, the time-difference signal is a first delay signal obtained by delaying the video signal, the scene change frame detection unit detects a post-scene-change frame, which is a frame immediately after a scene change, among frames included in the video signal based on the video signal and the first delay signal, and the noise reduction processing unit weakens noise reduction of inter-frame noise for an image signal of the post-scene-change frame detected by the scene change frame detection unit.

(4) In the noise reduction apparatus according to the aspect of the present invention, the scene change frame detection unit includes a delay unit that generates the first delay signal by delaying the video signal by the predetermined first number of frames and a detection unit that detects the post-scene-change frame among the frames included in the video signal based on the video signal and the time-difference signal generated by the delay unit.

(5) In the noise reduction apparatus according to the aspect of the present invention, the delay unit generates a second delay signal by delaying the video signal by a second number of frames, which is more than the first number of frames and the noise reduction processing unit weakens noise reduction of inter-frame noise for the second delay signal in a frame corresponding to the post-scene-change frame detected by the detection unit.

(6) In the noise reduction apparatus according to the aspect of the present invention, the noise reduction processing unit reduces the inter-frame noise of the second delay signal based on the first delay signal and the second delay signal for the second delay signal in a frame corresponding to a frame other than the post-scene-change frame detected by the detection unit.

(7) In the noise reduction apparatus according to the aspect of the present invention, the delay unit generates a third delay signal by delaying the video signal by a third number of frames, which is more than the second number of frames, and the noise reduction processing unit reduces the inter-frame noise based on the first delay signal, the second delay signal, and the third delay signal for the second delay signal in a frame corresponding to a frame other than the post-scene-change frame detected by the detection unit.

(8) In the noise reduction apparatus according to the aspect of the present invention, the detection unit includes an inter-frame difference calculation unit that calculates an inter-frame difference value, which is a pixel value difference between the video signal and the time-difference signal, for each frame based on the video signal and the time-difference signal and a determination unit that determines whether a scene change has been done for each frame based on the inter-frame difference value calculated by the inter-frame difference calculation unit for each frame, and the noise reduction processing unit weakens, when the determination unit determines that a scene change has been done, noise reduction of the inter-frame noise for a target frame for which a scene change has been detected.

(9) The noise reduction apparatus according to the aspect of the present invention further including a signal generation unit that generates, when the determination unit determines that a scene change has been done, a scene change detection signal indicating that a scene change has been done in a target frame for which a scene change has been done and a frame immediately before the target frame, wherein the noise reduction processing unit weakens noise reduction of the inter-frame noise for a frame for which a scene change has been detected by the scene change detection signal among frames included in the video signal.

(10) In the noise reduction apparatus according to the aspect of the present invention, the time-difference signal is an early signal obtained by advancing the video signal and the scene change frame detection unit detects a frame immediately before or immediately after a scene change among frames included in the video signal or the early signal based on the video signal and the early signal.

(11) A display apparatus according to the aspect of the present invention include the noise reduction apparatus described above.

(12) A noise reduction method executed by a noise reduction apparatus according to an aspect of the present invention includes a scene change frame detection process of detecting at least one of frames immediately before and immediately after a scene change among frames included in a video signal or a time-difference signal having a time difference from the video signal based on the video signal and the time-difference signal, and a noise reduction process of weakening noise reduction of inter-frame noise superimposes between frames for an image signal of the at least one of frames detected by the scene change frame detection process.

(13) A noise reduction program according to an aspect of the present invention causes a computer to execute a scene change frame detection step that detects at least one of frames immediately before and immediately after a scene change among frames included in a video signal or a time-difference signal having a time difference from the video signal based on the video signal and the time-difference signal, and a noise reduction step that weakens noise reduction of inter-frame noise superimposes between frames for an image signal of the at least one of frames detected by the scene change frame detection step.

### Advantageous Effects of Invention

According to the present invention, video easily viewable to audiences can be provided.

### BRIEF DESCRIPTION OF DRAWINGS

FIG. 1 is a block diagram schematically showing a display apparatus according to a first embodiment.

FIG. 2 is a block diagram schematically showing a liquid crystal display unit according to the first embodiment.

FIG. 3 is a block diagram schematically showing the structure of a noise reduction unit according to the first embodiment.

FIG. 4 is a block diagram schematically showing the structure of a scene change frame detection unit according to the first embodiment.

FIG. 5 is a block diagram schematically showing the structure of a detection unit according to the first embodiment.

FIG. 6 is a diagram describing generation processing of scene change detection signal C according to the first embodiment.

FIG. 7 is a block diagram schematically showing the structure of a noise reduction processing unit according to the first embodiment.

FIG. 8 is a diagram for describing processing by the noise reduction processing unit according to the first embodiment.

FIG. 9 is a flowchart showing a flow of processing by a display apparatus according to the first embodiment.

FIG. 10 is an example of a flowchart showing a flow of scene change detection processing in step S102 in FIG. 9.

FIG. 11 is an example of a flowchart showing a flow of noise reduction processing in step S103 in FIG. 9.

FIG. 12 is a block diagram schematically showing a display apparatus according to a second embodiment.

FIG. 13 is a block diagram schematically showing a noise reduction unit according to the second embodiment.

FIG. 14 is a block diagram schematically showing a scene change frame detection unit according to the second embodiment.

FIG. 15 is a block diagram schematically showing the structure of a detection unit according to the second embodiment.

FIG. 16 is a diagram describing generation processing of scene change detection signal C according to the second embodiment.

FIG. 17 is a block diagram schematically showing the structure of a noise reduction processing unit according to the second embodiment.

FIG. 18 is a diagram for describing processing by the noise reduction processing unit according to the second embodiment.

FIG. 19 is an example of a flowchart showing a flow of processing by scene change detection processing by the scene change frame detection unit according to the second embodiment.

FIG. 20 shows an example of a flowchart showing a flow of processing by the noise reduction processing unit according to the second embodiment.

FIG. 21 is a diagram showing time variations of the amount of noise when using a cyclic noise reduction apparatus described in PTL 1.

FIG. 22 is a diagram showing time variations of the amount of noise when using the noise reduction unit according to this embodiment.

FIG. 23 is a block diagram schematically showing the structure of a determination unit according to a first modification.

FIG. 24 is a block diagram schematically showing the structure of a determination unit according to a second modification.

FIG. 25 is a block diagram schematically showing the structure of a noise reduction processing unit according to the first modification.

FIG. 26 is a block diagram schematically showing the structure of a noise reduction processing unit according to the second modification.

### DESCRIPTION OF EMBODIMENTS

### First Embodiment

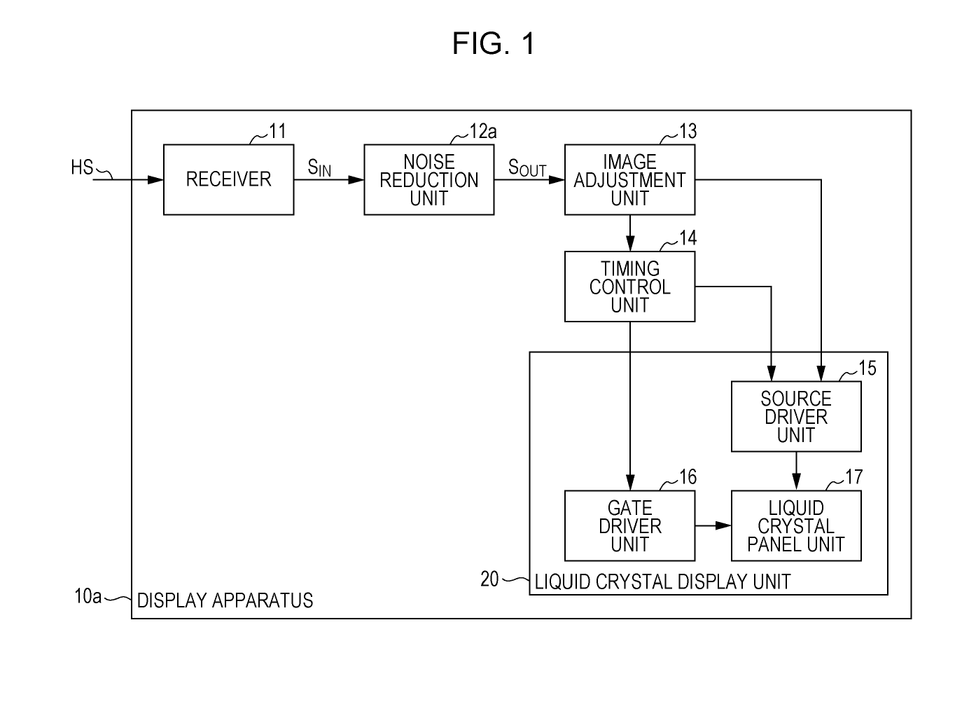

An embodiment of the present invention will now be described in detail with reference to the drawings. FIG. 1 is a block diagram schematically showing a display apparatus 10a according to a first embodiment. The display apparatus 10a includes a receiver 11, a noise reduction unit 12a, an image adjustment unit 13, a timing control unit 14, and a liquid crystal display unit 20. The liquid crystal display unit 20 includes a source driver unit 15, a gate driver unit 16, and a liquid crystal panel unit 17.

The receiver 11 receives, for example, a plurality of channels of high frequency signals HS for digital television broadcasting supplied from an antenna (not shown). The receiver 11 extracts a desired channel of a high frequency signal HS from the received signals, converts the extracted high frequency signal into a base band signal, and converts the converted base band signal into a digital signal at a predetermined sampling frequency.

Note that the receiver 11 may have the function of receiving the plurality of channels of high frequency signals HS for digital television broadcasting supplied from the antenna (not shown) and converting the received high frequency signals HS into digital signals.

The receiver 11 extracts a digital data moving picture experts group (MPEG)-2 transport stream (referred to below as MPEG-2TS) signal from the converted digital signals.

The receiver 11 extracts transport stream (TS) packets from the MPEG-2TS signal to decode video signal and voice signal data. In the following, video signal processing is exclusively described and voice signal processing is not described.

The receiver 11 converts the decoded video signal from an interlaced signal to a progressive signal. Then, the receiver 11 supplies video signal S_{IN} that has been converted into the progressive signal, to the noise reduction unit 12a and a video storage processing unit 21. Video signal S_{IN} is a progressive signal including, for example, the brightness signal of pixels adjacently arranged in the main scanning direction (lateral direction, horizontal direction) of an image, the color difference signal (Cb, Cr), a horizontal synchronization signal HSYMC, and a vertical synchronization signal VSYMC.

The noise reduction unit 12a receives a video signal S_{IN} supplied from the receiver 11. The noise reduction unit 12a calculates a noise reduction signal S_{OUT} from which noise has been reduced from video signal S_{IN} through a process described later, and supplies noise reduction signal S_{OUT} to the image adjustment unit 13.

The image adjustment unit 13 performs scaling for adjusting, based on the resolution of the display unit, the number of pixels of noise reduction signal Soul supplied from the noise reduction unit 12a. The image adjustment unit 13 converts the video signal that has been subject to scaling into RGB signals (red, green, and blue color video signals). The image adjustment unit 13 supplies the RGB signals to the timing control unit 14 and the source driver unit 15 in the liquid crystal display unit 20.

If the television broadcasting signal supplied from an antenna (not shown) is a progressive signal, the image adjustment unit 13 does not perform the above conversion from an interlaced signal to a progressive signal. In this case, the image adjustment unit 13 performs scaling for adjusting the number of pixels of noise reduction signal S_{OUT} based on the resolution of the display unit.

The timing control unit 14 generates a clock signal and so on for distributing video data supplied to the liquid crystal panel unit 17 to pixels on a plane. The timing control unit 14 supplies the generated clock signal to the source driver unit 15 in the liquid crystal display unit 20 and a gate driver unit 16.

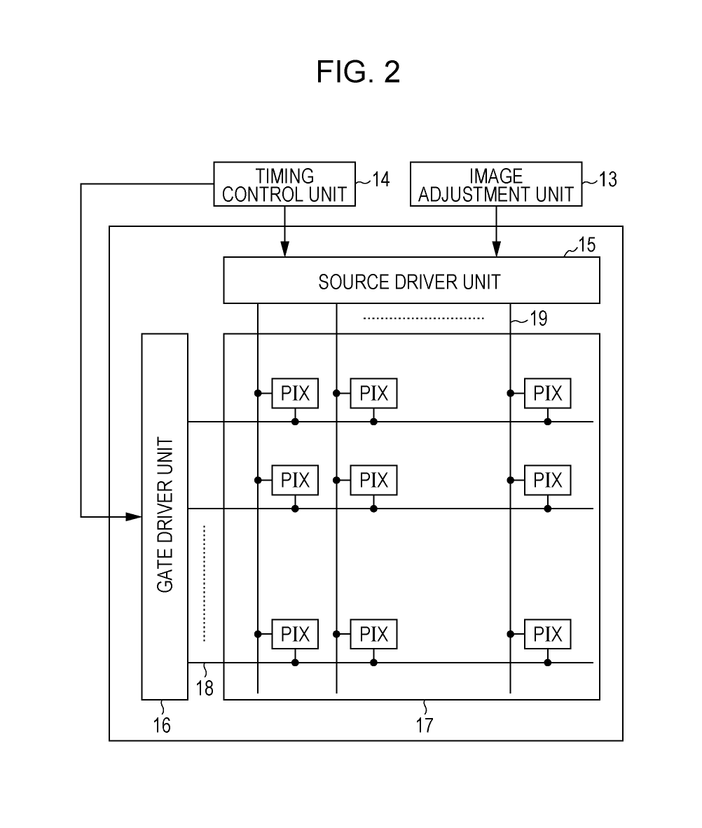

FIG. 2 is a block diagram schematically showing the liquid crystal display unit 20 according to the first embodiment. The liquid crystal display unit 20 is an active matrix display apparatus, for example. The liquid crystal display unit 20 includes the liquid crystal panel unit 17, a gate line 18, a source line 19, the gate driver unit 16 that drives the gate line 18, and the source driver unit 15 that drives the source line 19. The liquid crystal panel unit 17 has a display element PIX arranged at the intersection of the source line 19 and the gate line 18, i.e., a display element PIX arranged at a matrix. The display element PIX includes a thin film transistor (TFT) and a liquid crystal pixel element to which the TFT supplies a voltage corresponding to a gray level.

The source driver unit 15 uses an internal holding circuit to hold RGB signals (for example, digital signals representing the pixel values of red, green, and blue) supplied from the image adjustment unit 13 for each of the source lines 19 (wires in the row direction) of the liquid crystal panel unit 17.

When receiving a clock signal supplied from the timing control unit 14, the source driver unit 15 generates, in sync with the clock signal, a pixel element driving voltage (source signal) corresponding to a gray level based on the RGB signals held by the source driver unit 15, for arrangement in the vertical direction of the screen, and supplies the generated source signal to the display element PIX via the source line 19 of the liquid crystal panel unit 17. This supplies the source signal to the liquid crystal pixel element via the TFT.

The gate driver unit 16 receives the clock signal supplied from the timing control unit 14. The gate driver unit 16 supplies, in sync with the clock signal, a predetermined scanning signal to the gate of each TFT for one line of subpixels of the screen via the gate line 18 of the TFT of the liquid crystal panel unit 17.

The liquid crystal panel unit 17 includes an array board, an opposed board, and a liquid crystal panel. A pair of a pixel electrode and an opposed electrode (including a strip electrode of the opposed board) connected to a TFT and the drain electrode of the TFT is arranged for each of the intersections of gate lines and data lines on the array board to configure a pixel, particularly a subpixel. Enclosed liquid crystal is present between the pixel electrode and the opposed electrode. The liquid crystal panel unit 17 has three subpixels (not shown) corresponding to the three elementary colors (red, green, and blue) for each pixel. The liquid crystal panel unit 17 has one TFT for each of the subpixels. The subpixels are connected to the gate line 18 and the source line 19 via their TFTs, which are switching elements.

The gate electrode of a TFT receives a gate signal supplied from the gate driver unit 16. If the level of the gate signal is high, the TFT is selected and set to ON. Since the source electrode of the TFT receives a source signal supplied from the source driver unit 15, a voltage corresponding to a gray level appears on the pixel electrode connected to the drain electrode of the TFT.

The orientation of liquid crystal varies depending on the voltage corresponding to a gray level, thereby changing the optical transparency of liquid crystal. The voltage corresponding to the gray level is held by a liquid crystal capacitor configured between the pixel electrode and the opposed electrode connected to the drain electrode of the TFT and the orientation of liquid crystal is kept. Until the next signal reaches the source electrode, the orientation of liquid crystal is kept and, as a result, the optical transparency of liquid crystal is kept.

In such a way described above, the liquid crystal panel unit 17 displays the gray level of supplied video data. A transparent liquid crystal panel is adopted in the present embodiment, but a reflective liquid crystal panel can also be used.

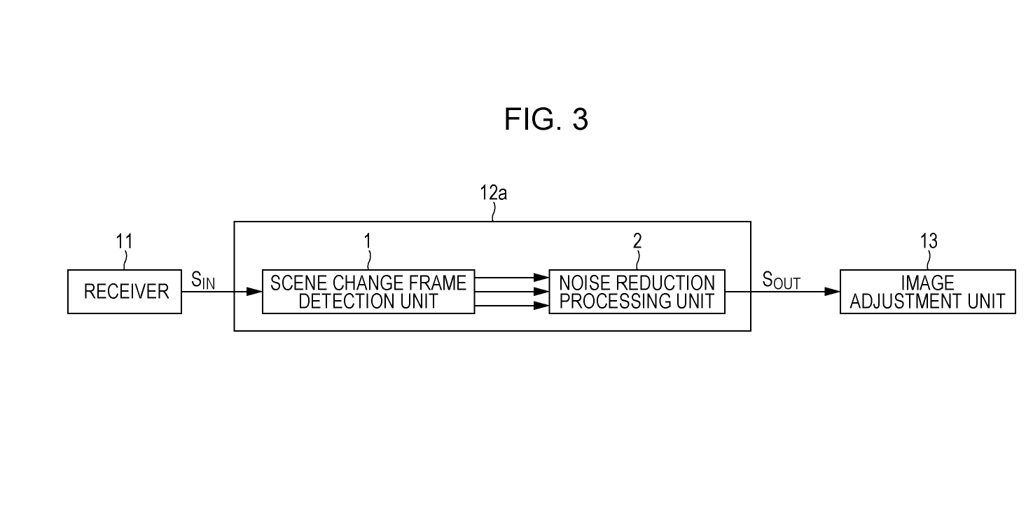

FIG. 3 is a block diagram schematically showing the structure of the noise reduction unit 12a according to the first embodiment. The noise reduction unit 12a includes a scene change frame detection unit 1 and a noise reduction processing unit 2.

For example, the scene change frame detection unit 1 according to the present embodiment detects a post-scene-change frame, which is a frame immediately after a scene change from video signal S_{IN}, from video signal S_{IN} based on video signal S_{IN} and a first delay signal obtained by delaying video signal S_{IN} by a predetermined first number of frames.

Then, the scene change frame detection unit 1 generates a scene change signal C based on the detected post-scene-change frame and supplies the generated scene change signal C to the noise reduction processing unit 2.

For example, the noise reduction processing unit 2 according to the present embodiment performs weakening of noise reduction of inter-frame noise superimposed between frames with respect to the image signal of a frame immediately after a scene change detected by the scene change frame detection unit 1. The weakening of noise reduction according to the present embodiment means that, for example, based on the amount of noise reduction of a frame immediately before a frame immediately before which 10 scenes are changed, noise reduction is performed with an amount (including 0) less than the amount of noise reduction.

The noise reduction processing unit 2 may perform noise reduction, based on the amount of noise reduction of a frame after a frame immediately after a scene change, with an amount (including 0) less than the amount of noise reduction. The noise reduction processing unit 2 may perform noise reduction, based on the predetermined standard amount of noise reduction, with an amount (including 0) less than the amount of noise reduction.

The noise reduction processing unit 2 supplies the noise-reduced video signal to the image adjustment unit 13 as noise reduction signal San.

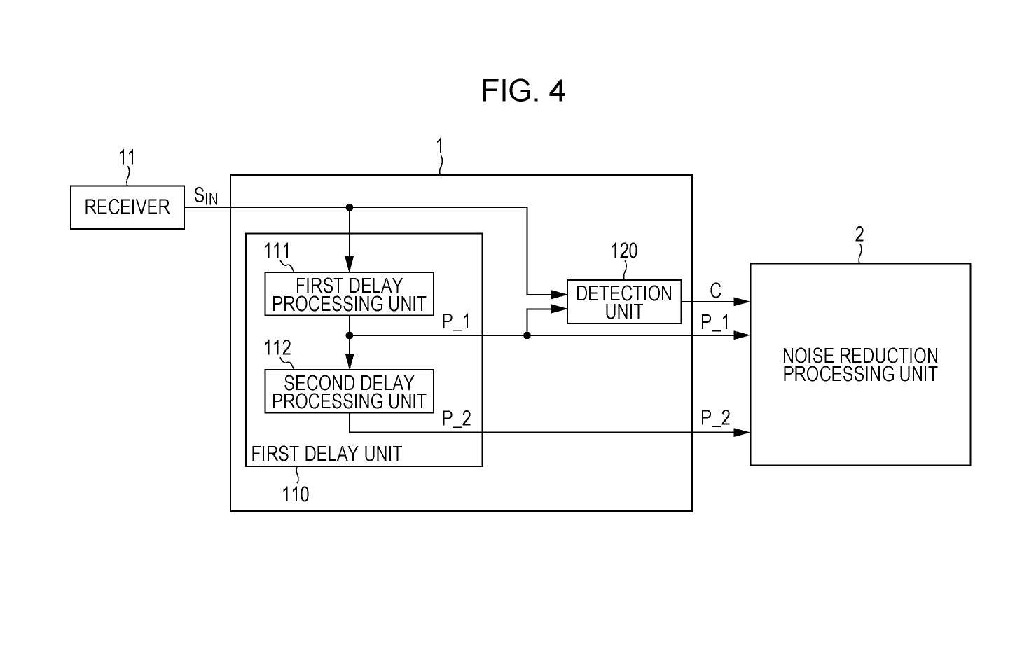

FIG. 4 is a block diagram schematically showing the structure of the scene change frame detection unit 1 according to the first embodiment. The scene change frame detection unit 1 includes a first delay unit (delay unit) 110 and a detection unit 120.

The first delay unit 110 generates the first delay signal described above by delaying video signal S_{IN} supplied from the receiver 11 by the predetermined first number of frames. In addition, the first delay unit 110 generates the second delay signal by delaying video signal S_{IN} by the second number of frames, which is larger than the first number of frames described above. The first delay unit 110 includes a first delay processing unit 111 and the second delay processing unit 112.

The first delay processing unit 111 generates first delay signal P_1 by delaying video signal S_{IN} supplied from the receiver 110 by the predetermined first number of frames (for example, one frame in this embodiment). Then, the first delay unit 110 supplies the generated first delay signal P_1 to the second delay processing unit 112 and the detection unit 120.

The second delay processing unit 112 generates second delay signal P_2 by delaying first delay signal P_1 supplied from the first delay processing unit 111 by the predetermined second number of frames (for example, one frame in this embodiment). The second delay processing unit 112 supplies the generated second delay signal P_2 to the noise reduction processing unit 2.

Based on video signal S_{IN} supplied from the receiver 11 and first delay signal P_1 supplied from the first delay processing unit 111, the detection unit 120 detects a post-scene-change frame from a frame included in video signal S_{IN}. The detection unit 120 generates scene change detection signal C based on the detected post-scene-change frame. Specifically, for example, when a post-scene-change frame is detected from video signal S_{IN}, the detection unit 120 sets the scene change detection signal C to 1 while video signal S_{IN} indicates the image signal of the frame next to the post-scene-change frame. In the other period of time, the detection unit 120 sets the scene change detection signal C to 0.

The detection unit 120 supplies the generated scene change detection signal C to the noise reduction processing unit 2.

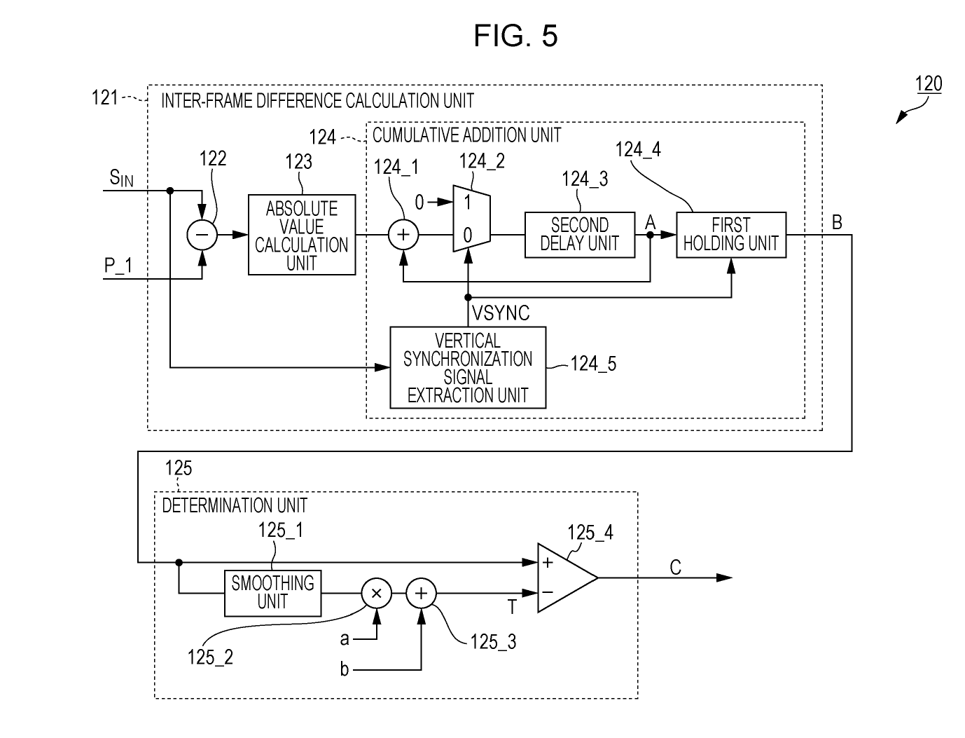

FIG. 5 is a block diagram schematically showing the structure of the detection unit 120 according to the first embodiment. The detection unit 120 includes an inter-frame difference calculation unit 121 and a determination unit 125.

Based on video signal S_{IN} supplied from the receiver 11 and first delay signal P_1 supplied from the first delay processing unit 111, the inter-frame difference calculation unit 121 calculates an inter-frame difference value for each frame, which is a pixel value difference between the video signal and first delay signal P_1.

The inter-frame difference calculation unit 121 includes a difference calculation unit 122, an absolute value calculation unit 123, and a cumulative addition unit 124.

The difference calculation unit 122 subtracts first delay signal P_1 supplied from the first delay processing unit 111 from video signal S_{IN} supplied from the receiver 11 and supplies a post-subtraction signal indicating the value after subtraction to the absolute value calculation unit 123.

The absolute value calculation unit 123 calculates the absolute value of the value indicated by the post-subtraction signal supplied from the difference calculation unit 122 and supplies an absolute value signal indicating the calculated absolute value to the cumulative addition unit 124.

The cumulative addition unit 124 calculates an inter-frame difference value by adding the absolute value indicated by the absolute value signal supplied from the absolute value calculation unit 123 by one frame. That is, the cumulative addition unit 124 calculates the inter-frame difference value by adding the absolute value of difference in each pixel across effective pixels in one frame for each frame. Then, the cumulative addition unit 124 supplies inter-frame difference signal B indicating the calculated inter-frame difference value to the determination unit 125. The cumulative addition unit 124 holds.

The cumulative addition unit 124 includes a first addition unit 124_1, a selection unit 124_2, a second delay unit 124_3, a first holding unit 124_4, and a vertical synchronization signal extraction unit 124_5.

The first addition unit 124_1 adds the absolute signal supplied from the absolute value calculation unit 123 and cumulative addition signal A indicating a cumulative addition value supplied from the second delay unit 124_3 and supplies a signal after addition to the selection unit 124_2.

The vertical synchronization signal extraction unit 124_5 extracts the vertical synchronization signal VSYMC from video signal S_{IN} supplied from the receiver 11, and supplies the extracted vertical synchronization signal VSYMC to the selection unit 124_2 and the first holding unit 124_4.

When the vertical synchronization signal VSYMC supplied from the vertical synchronization signal extraction unit 124_5 is 0, the selection unit 124_2 supplies the signal after addition supplied from the first addition unit 124_1 to the second delay unit 124_3. The vertical synchronization signal VSYMC is 1 in the vertical retrace section or 0 in the other sections. That is, while image signals in one frame are input, the selection unit 124_2 supplies the added signal supplied from the first addition unit 124_1 to the second delay unit 124_3.

In contrast, when the vertical synchronization signal VSYMC with a value of 1 is supplied to the selection unit 124_2 in the vertical retrace section, a signal indicating a value of 0 held by the cumulative addition unit 124 is output to the second delay unit 124_3. This resets the cumulative addition signal A output from the second delay unit 124_3.

The second delay unit 124_3 delays a signal supplied from the selection unit 124_2 by only one pixel clock. Then, the second delay unit 124_3 supplies the signal delayed by one pixel clock to the first addition unit 124_1 and the first holding unit 124_4 as the cumulative addition signal A.

This causes the first addition unit 124_1 to perform cumulative addition by adding the cumulative addition value of up to the pixel one pixel before the current pixel input from the second delay unit 124_3 to the absolute value of a difference input from the absolute value calculation unit 123 in sections other than the retrace section. In contrast, the first addition unit 124_1 adds the absolute value of the difference input from the absolute value calculation unit 123 to the cumulative addition signal of the second delay unit 124_3. However, the selection unit 124_2 selects a fixed value of 0, so an output from the absolute value calculation unit 123 is not reflected on the cumulative addition signal A of the second delay unit 124_3.

Upon detection of the leading edge of a 0-to-1 transition of the vertical synchronization signal VSYMC supplied from the vertical synchronization signal extraction unit 124_5, the first holding unit 124_4 holds the cumulative addition signal A supplied from the second delay unit 124_3. Then, the first holding unit 124_4 supplies the held cumulative addition signal A to the determination unit 125 as inter-frame difference signal B until detection of the leading edge of the next 0-to-1 transition of the vertical synchronization signal VSYMC. The first holding unit 124_4 is a D-type flip-flop, for example.

The determination unit 125 determines whether a scene change is made for each frame based on the inter-frame difference value calculated by the inter-frame difference calculation unit 121 for each frame. The determination unit 125 generates a determination result signal indicating a determination result and supplies the generated determination signal to the noise reduction processing unit 2 as the scene change detection signal C. In addition, the determination unit 125 holds a signal indicating slope a and a signal indicating intercept b.

The determination unit 125 includes a smoothing unit 125_1, a first multiplication unit 125_2, a second addition unit 125_3, and a comparison unit 125_4.

The smoothing unit 125_1 smooths inter-frame difference signal B supplied from the cumulative addition unit 124 across a plurality of frame sections. Specifically, for example, the smoothing unit 125_1 calculates the average of a predetermined number (for example, the previous eight frames) of the inter-frame difference values of the previous frames. The smoothing unit 125_1 supplies smoothing signal Sm indicating a smoothing value obtained by the smoothing to the first multiplication unit 125_2.

The first multiplication unit 125_2 multiplies smoothing signal Sm supplied from the smoothing unit 125_1 by the signal indicating slope a, and supplies a multiplication signal obtained by the multiplication to the second addition unit 125_3.

The second addition unit 125_3 adds the signal indicating intercept b to the multiplication signal supplied from the first multiplication unit 125_2, and supplies an added signal obtained by the addition to the comparison unit 125_4 as threshold signal T.

The comparison unit 125_4 performs comparison between inter-frame difference signal B supplied from the cumulative addition unit 124 and threshold signal T supplied from the second addition unit 125_3 and generates scene change detection signal C based on the comparison. Specifically, for example, when inter-frame difference signal B is equal to or more than threshold T, the comparison unit 125_4 sets scene change detection signal C to 1. Otherwise, the comparison unit 125_4 sets scene change detection signal C to 0.

The comparison unit 125_4 supplies the generated scene change detection signal C to the noise reduction processing unit 2.

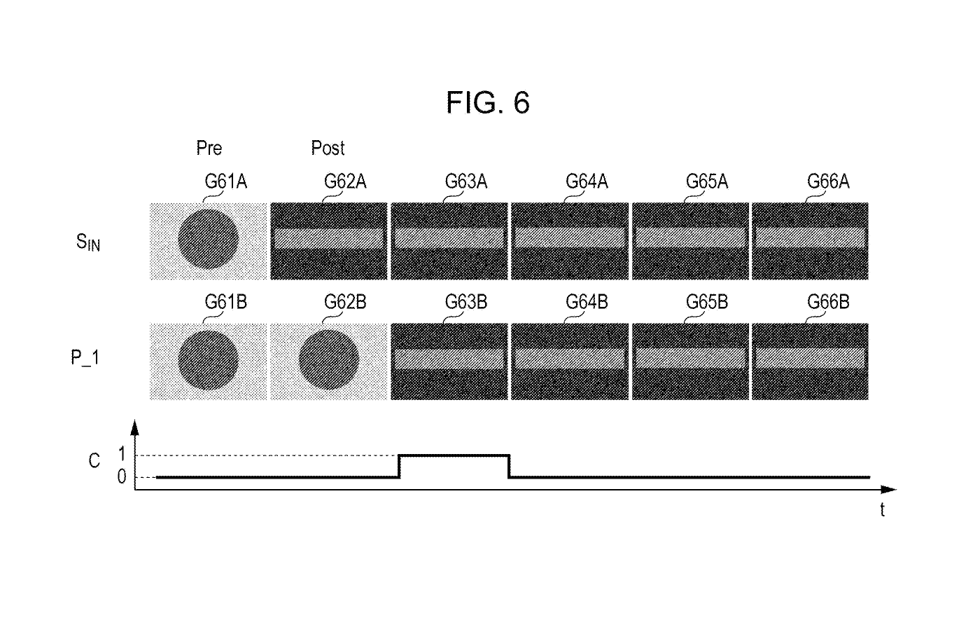

FIG. 6 is a diagram describing generation processing of scene change detection signal C according to the first embodiment. In FIG. 6, on the first line, frame images G61A to G66A indicated by video signal S_{IN} are arranged from left to right in order of appearance. On the second line, frame images G61B to G66B indicated by first delay signal P_1 are arranged from left to right in order of appearance. On the third line, time variations of scene change detection signal C are indicated when video signal S_{IN} on the first line and delay signal P_1 on the second line are provided. In the graph on the third line, the vertical axis represents scene change detection signal C and the horizontal axis represents time t. In the upper/lower direction of FIG. 6, the images or the values of scene change detection signal C at the same hour are arranged.

In FIG. 6, the images of the frames included in first delay signal P_1 are one frame behind the images of video signal S_{IN}. Specifically, image G62B is image G61A and image G63B is image G62A. In addition, image G64B is image G63A, image G65B is image G64A, and image G66B is image G65A.

It is also found that, when the image indicated by video signal S_{IN} is G63A, scene change detection signal C becomes 1. Otherwise, scene change detection signal C becomes 0.

In the images of the frames included in video signal S_{IN}, image G61A is a pre-image immediately before a scene change is made and image G62A is a post-image immediately after a scene change is made.

In FIG. 6, the detection unit 120 determines that a scene change has been done in the frame of image G62A included in video signal S_{IN} based on a signal indicating image G62A of video signal S_{IN} and a signal indicating image G62B of first delay signal P_1.

Then, the detection unit 120 changes the value indicated by scene change detection signal C from 0 to 1 immediately before video signal S_{IN} indicates the image signal of image G63A. Next, the detection unit 120 changes the value indicated by scene change detection signal C from 1 to 0 immediately before video signal S_{IN} indicates the image signal of image G64A.

That is, the detection unit 120 sets the value indicated by scene change detection signal C to 1 in the frame next to the frame immediately after a scene change or sets the value indicated by scene change detection signal C to 0 in subsequent frames.

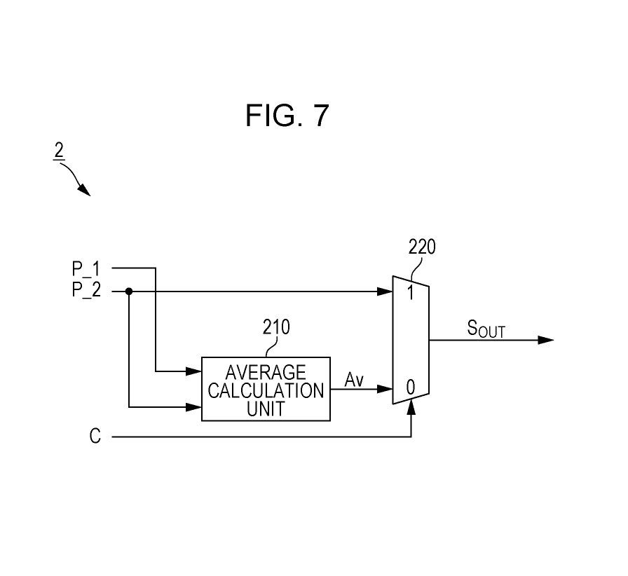

FIG. 7 is a block diagram schematically showing the structure of the noise reduction processing unit 2 according to the first embodiment. The noise reduction processing unit 2 includes an average calculation unit 210 and a switching unit 220.

The noise reduction processing unit 2 weakens noise reduction of inter-frame noise for the second delay signal in a frame corresponding to a post-scene-change frame detected by the detection unit 120.

That is, the noise reduction processing unit 2 weakens noise reduction of inter-frame noise with respect to the frame detected by the detection unit 120 for which the scene change detection signal indicates the detection of a scene change among the frames included in the video signal.

On the other hand, the noise reduction processing unit 2 reduces the inter-frame noise in the second delay signal in a frame corresponding to a frame other than a post-scene-change frame detected by the detection unit 120.

The average calculation unit 210 generates average signal Av indicating the average of first delay signal P_1 and second delay signal P_2 supplied from the first delay unit 110 and supplies the generated average signal Av to the switching unit 220.

The switching unit 220 determines whether to reduce second delay signal P_2 based on scene change detection signal C supplied from the detection unit 120. Specifically, the switching unit 220 switches between second delay signal P_2 supplied from the first delay unit 110 and average signal Av supplied from the average calculation unit 210, based on scene change detection signal C supplied from the detection unit 120.

For example, the switching unit 220 selects second delay signal P_2 when scene change detection signal C is 1 or selects average signal Av when scene change detection signal C is 0. Then, the switching unit 220 supplies the selected signal as noise reduction signal S_{OUT} to the image adjustment unit 13.

Accordingly, the noise reduction processing unit 2 supplies second delay signal P_2 itself as noise reduction signal S_{OUT} to the image adjustment unit 13 without reducing noise in second delay signal P_2 when the detection unit 120 determines that a scene change has occurred. In contrast, when the detection unit 120 determines that a scene change has not been made, the noise reduction processing unit 2 supplies noise-reduced average signal Av to the image adjustment unit 13 as noise reduction signal S_{OUT}.

As a result, the noise reduction processing unit 2 outputs an image signal immediately before a scene change without calculating the average of a frame immediately after the scene change and a frame immediately before the scene change, thereby preventing the afterimage of the image of a frame immediately after the scene change from remaining in an image indicated by noise reduction signal S_{OUT}, which is an output.

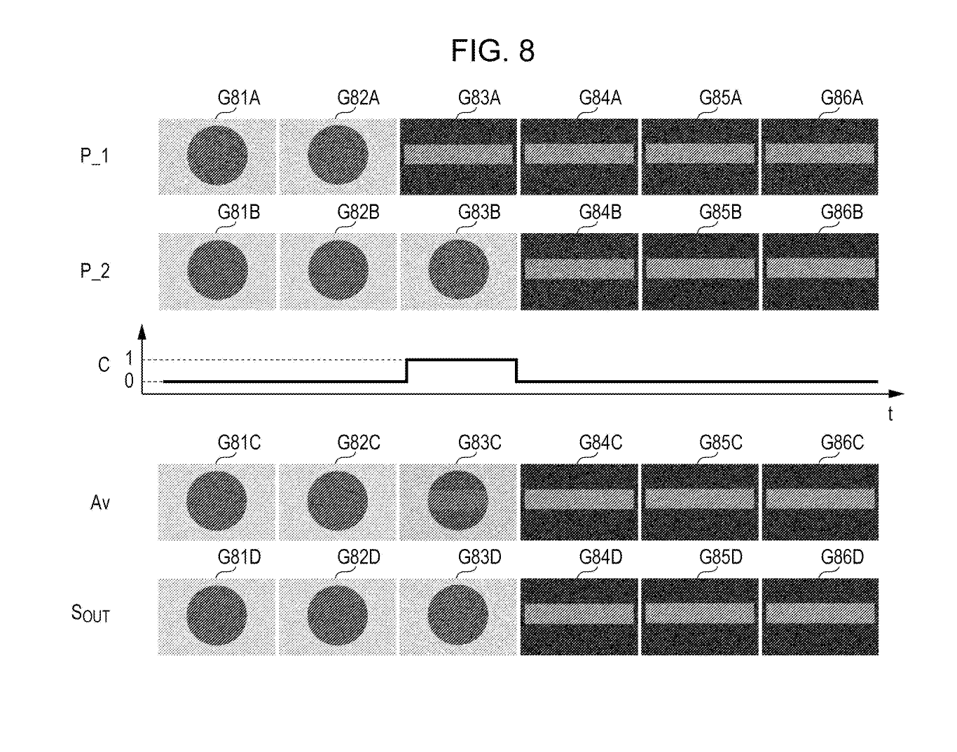

Processing by the noise reduction processing unit 2 will be described with reference to FIG. 8 in a case where video signal S_{IN} indicates the image displayed in FIG. 6. FIG. 8 is a diagram for describing processing by the noise reduction processing unit 2 according to the first embodiment. In FIG. 8, on the first line, images G81A to G86A indicated by first delay signal P_1 are arranged from left to right in order of appearance. On the second line, images G81B to G86B indicated by second delay signal P_2 are arranged from left to right in order of appearance.

On the third line, time variations of scene change detection signal C are arranged. In the graph on the third line, the vertical axis represents scene change detection signal C and the horizontal axis represents time t. On the fourth line, images G81C to G86C of frames indicated by average signal Av output from the average calculation unit 210 are arranged from left to right in order of appearance. On the fifth line, images G81D to G86D of frames indicated by noise reduction signal S_{OUT} output from the switching unit 220 are arranged from left to right in order of appearance. In the upper/lower direction of FIG. 8, the images or the values of scene change detection signal C at the same hour are arranged.

In FIG. 8, the images indicated by second delay signal P_2 are one frame behind the images indicated by first delay signal P_1. On the fourth line, the pixel values of an image indicated by average signal Av output from the average calculation unit 210 are the averages of the pixels included in an image indicated by first delay signal P_1 and the pixel values of pixels in positions equivalent to the pixels in an image indicated by second delay signal P_2. In image G83C of FIG. 8, an afterimage of image G83A of first delay signal P_1 remains on image G83B of second delay signal P_2.

When the scene change detection signal is 1, image G83D indicated on the fifth line by noise reduction signal S_{OUT} output from the selection unit 220 is an image indicated by second delay signal P_2. On the other hand, the image indicated by noise reduction signal S_{OUT} on the fifth line is an image indicated by average signal Av.

This causes the noise reduction processing unit 2 to output the image of a frame immediately before a scene change without averaging the pixel values of the images of frames before and after the scene change, thereby preventing the afterimage of an image immediately after the scene change from remaining on the image indicated by noise reduction signal S_{OUT}, which is an output.

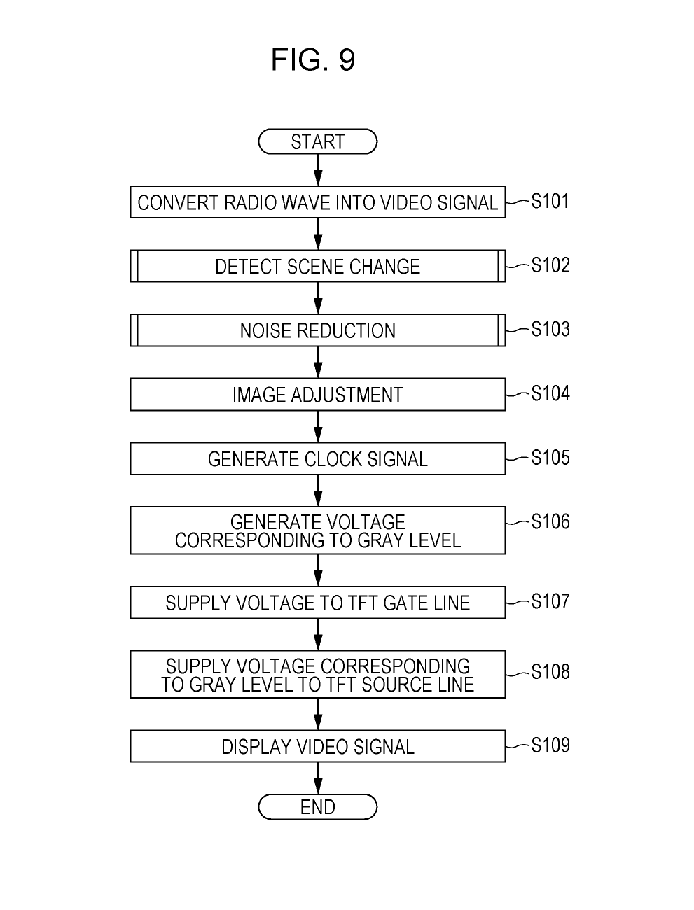

FIG. 9 is a flowchart showing a flow of processing by a display apparatus 10a according to the first embodiment. First, the receiver 11 receives radio waves from an antenna. The receiver 11 converts the received radio waves into a video signal (step S101). The receiver 11 supplies the converted video signal to the noise reduction unit 12a.

Next, the scene change frame detection unit 1 of the noise reduction unit 12a detects whether a scene change has been done for each of the frames included in the video signal (step S102). Then, the noise reduction unit 12a supplies scene change detection signal C obtained through the detection to the noise reduction processing unit 2.

Next, the noise reduction processing unit 2 applies noise reduction to video signal S_{IN} based on scene change detection signal C, generates noise reduction signal S_{OUT}, and supplies the generated noise reduction signal S_{OUT} to the image adjustment unit 13 (step S103).

Next, the image adjustment unit 13 receives the noise-reduced brightness signal supplied from the noise reduction unit 12a. The image adjustment unit 13 performs I/P-conversion (conversion from an interlaced signal to a progressive signal) of the noise-reduced brightness signal (step S104). The image adjustment unit 13 adjusts the number of pixels of the signal that has been subject to I/P conversion. The image adjustment unit 13 supplies the adjusted signal for which the number of pixels has been adjusted, to the timing control unit 14 and the source driver unit 15.

Next, the timing control unit 14 receives the adjusted signal supplied from the image adjustment unit 13. The timing control unit 14 generates a clock signal for distributing the adjusted signal to pixels on a plane (step S105). The timing control unit 14 supplies the generated clock signal to the source driver unit 15 and the gate driver unit 16.

Next, the source driver unit 15 generates a liquid crystal driving voltage corresponding to a gray level from the adjusted signal (step S106). The source driver unit 15 holds, for source line, the voltage corresponding to a gray level in an internal holding circuit.

Next, the gate driver unit 16 supplies a predetermined voltage to the gate line of the TFT of the liquid crystal panel unit 17 (step S107).

Next, the source driver unit 15 supplies a voltage corresponding to a gray level to the source line of the TFT of the liquid crystal panel unit 17 in sync with the clock signal for the array in the vertical direction of the screen (step S108).

This allows video data to be supplied to source lines in sequence within a time when each gate line is selected and required data to be written to an pixel electrode via the TFT. Therefore, the pixel electrode changes the transparency of the corresponding liquid crystal depending on the voltage applied to the pixel electrode. As described above, the liquid crystal panel unit 17 displays video signal (step S109). Now, the processing of this flowchart is completed.

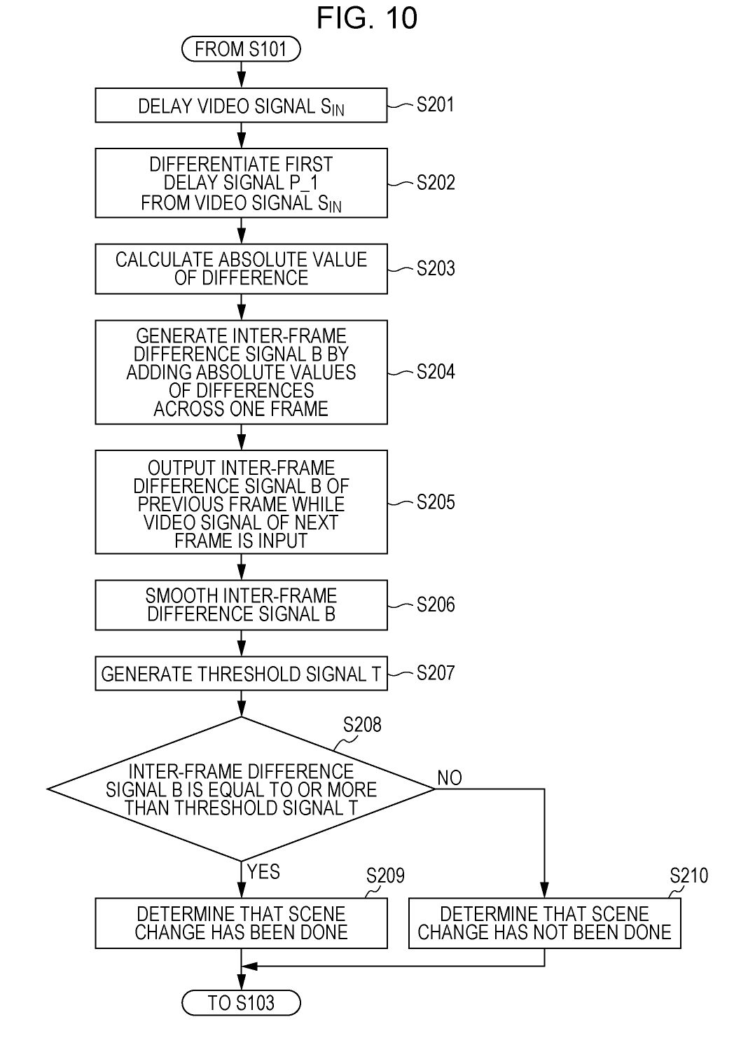

FIG. 10 is an example of a flowchart showing a flow of scene change detection processing in step S102 in FIG. 9. First, the first delay unit 110 generates a delay signal by delaying video signal S_{IN} (step S201). Next, the difference calculation unit 122 differentiates the delay signal from video signal S_{IN} (step S202). Next, the absolute value calculation unit 123 calculates the absolute value of the difference (step S203). Next, the cumulative addition unit 124 generates inter-frame difference signal B by adding absolute values of differences across one frame (step S204). Next, the cumulative addition unit 124 outputs inter-frame difference signal B of a target frame while the video signal of the frame next to the target frame is input (step S205).

The smoothing unit 125_1 generates smoothing signal Sm by smoothing inter-frame difference signal B across several latest frames (step S206). Next, the determination unit 125 generates threshold signal T based on smoothing signal Sm (step S207). Next, the determination unit 125 determines whether inter-frame difference signal B is equal to or more than threshold signal T (step S208). If inter-frame difference signal B is equal to or more than threshold signal T (YES in step S208), the determination unit 125 determines that a scene change has been done (step S209) and supplies scene change detection signal C with a value of 1 to the noise reduction processing unit 2. If inter-frame difference signal B is less than threshold signal T (NO in step S208), the determination unit 125 determines that a scene change has not been made (step S210) and supplies scene change detection signal C with a value of 0 to the noise reduction processing unit 2. Now, the processing of this flowchart is completed.

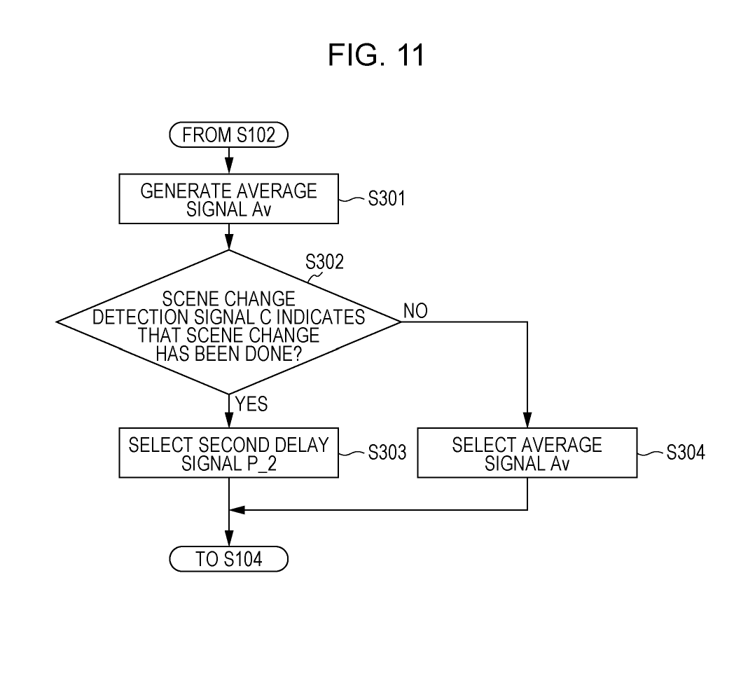

FIG. 11 is an example of a flowchart showing a flow of noise reduction processing in step S103 in FIG. 9. First, the average calculation unit 210 generates average signal Av, which is the average of first delay signal P_1 and second delay signal P_2 (step S301). Next, the switching unit 220 determines whether scene change detection signal C indicates a scene change (step S302). If scene change detection signal C indicates a scene change (YES in step S302), the switching unit 220 selects second delay signal P_2 as noise reduction signal S_{OUT} (step S303). In contrast, if scene change detection signal C does not indicate a scene change (NO in step S302), the switching unit 220 selects average signal Av as noise reduction signal S_{OUT} (step S304). Now, the processing of this flowchart is completed.

As described above, based on the video signal and first delay signal obtained by delaying the video signal by one frame, the noise reduction unit 12a according to the present embodiment detects a post-scene-change frame immediately after a scene change from the video signal. The noise reduction unit 12a does not reduce inter-frame noise superimposed between frames for the detected post-scene-change frame image signal. In contrast, as for the image signal of a frame other than a frame immediately after a scene change, the noise reduction unit 12a reduces inter-frame noise superimposed between frames by calculating the average of the image signal of each frame and the image signal of the frame immediately before the frame.

As a result, the noise reduction unit 12a outputs an image signal of a post-scene-change frame as is without generating the average image between a frame immediately after the scene change and a frame immediately before the scene change, thereby preventing the afterimage of the image of a frame immediately before the scene change from remaining in noise reduction signal S_{OUT}, which is an output.

In addition, the noise reduction unit 12a reduces inter-frame noise superimposed between frames by generating the average image of a frame other than the frame immediately after the scene change. This causes the noise reduction unit 12a to reduce inter-frame noise included in the frame other than the frame immediately after the scene change.

As described above, the noise reduction unit 12a prevents noise being superimposed on the image for a long period of time after the scene change, while preventing an afterimage from remaining on the image before and after the scene change. As a result, the noise reduction unit 12a can provide video easily viewable to audiences.

The noise reduction unit 12a according to the present embodiment outputs the image signal of a post-scene-change frame as is, but the noise reduction unit 12a may weaken the noise reduction of the image signal of a post-scene-change frame.

### Second Embodiment

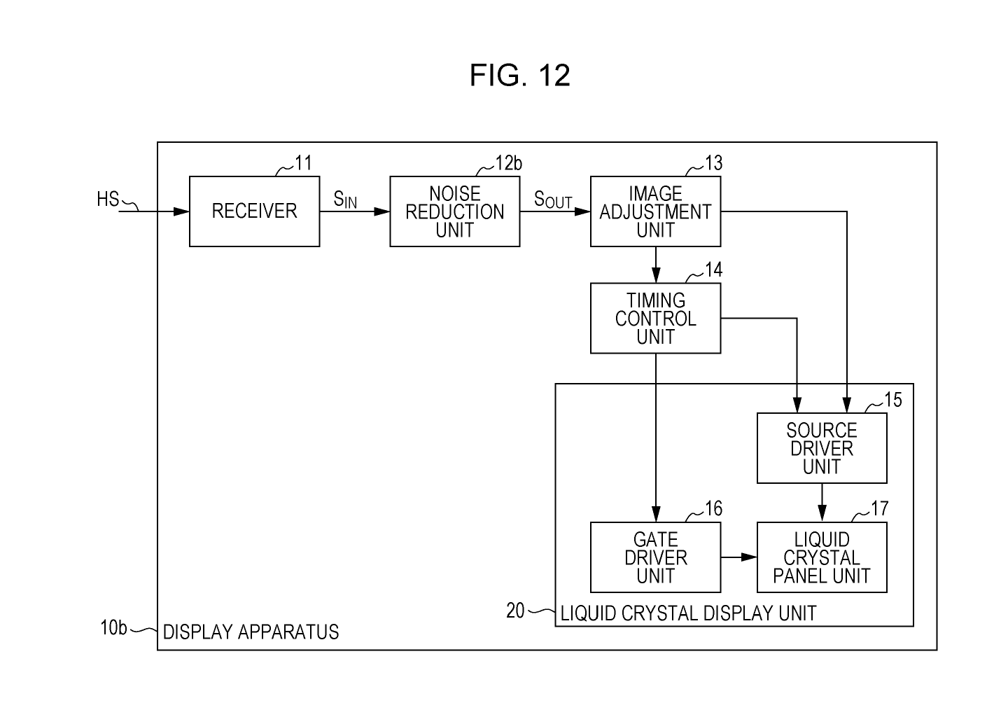

A second embodiment of the present invention will be described. FIG. 12 is a block diagram schematically showing a display apparatus 10b according to the second embodiment. The components common to those in FIG. 1 are given the same reference characters and their descriptions are omitted. In the structure of the display apparatus 10b shown in FIG. 12, the noise reduction unit 12a has been changed to the noise reduction unit 12b in the structure of the display apparatus 10a shown in FIG. 1.

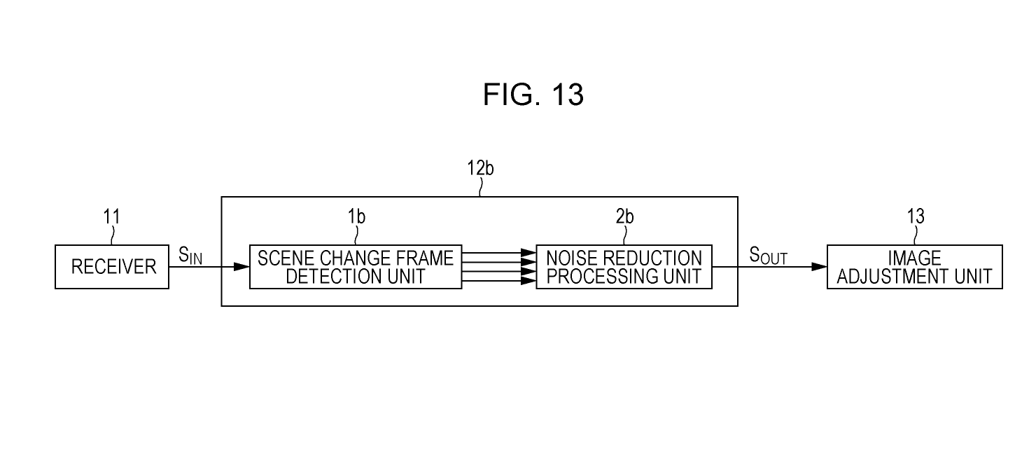

FIG. 13 is a block diagram schematically showing the noise reduction unit 12b according to the second embodiment. In the structure of the noise reduction unit 12b shown in FIG. 13, the scene change frame detection unit 1 has been changed to the scene change frame detection unit 1b in the structure of the noise reduction unit 12a shown in FIG. 3, and the noise reduction processing unit 2 has been changed to the noise reduction processing unit 2b the noise reduction processing unit 2b.

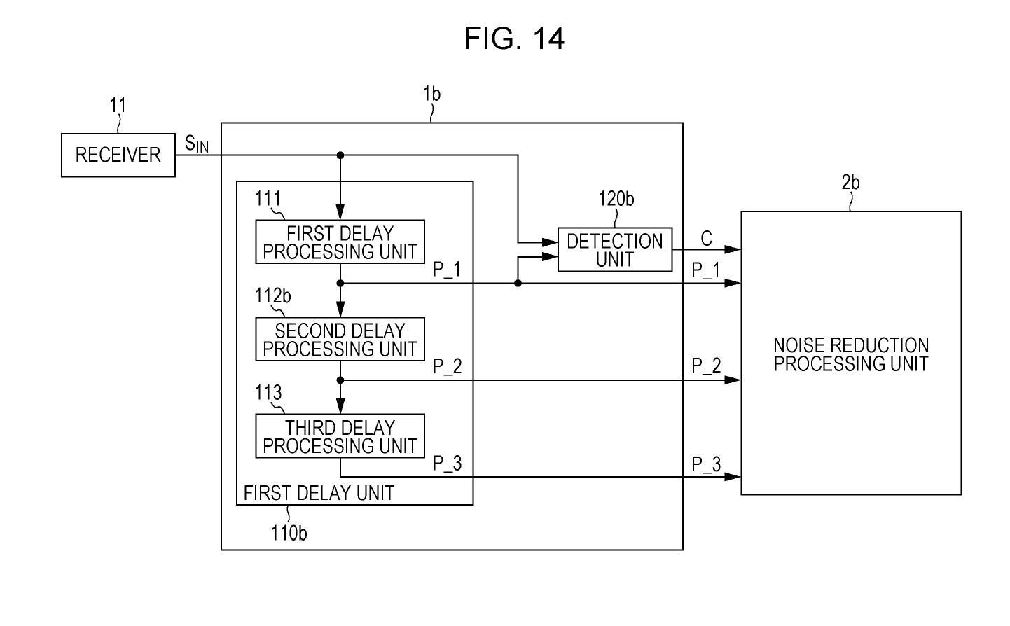

FIG. 14 is a block diagram schematically showing the scene change frame detection unit 1b according to the second embodiment. The components common to those in FIG. 4 are given the same reference characters and their descriptions are omitted. In the structure of the scene change frame detection unit 1b shown in FIG. 14, the first delay unit 110 has been changed to the first delay unit 110b and the detection unit 120 has been changed to the detection unit 120b in the scene change frame detection unit 1 shown in FIG. 4.

In the structure of the first delay unit 110b shown in FIG. 14, the second delay processing unit 112 has been changed to the second delay processing unit 112b and a third delay processing unit 113 has been added in the first delay unit 110 shown in FIG. 4.

The second delay processing unit 112b generates second delay signal P_2 by delaying first delay signal P_1 supplied from the first delay processing unit 111 by the second number of frames (for example, one frame in this embodiment). The second delay processing unit 112b supplies the generated second delay signal P_2 to the noise reduction processing unit 2b and the third delay processing unit 113.

The third delay processing unit 113 generates third delay signal P_3 by delaying second delay signal P_2 supplied from the second delay processing unit 112b by the predetermined third number of frames (for example, one frame in this embodiment). That is, the first delay unit 110b generates third delay signal by delaying the predetermined third number of frames, which is larger than the second number of frames. The third delay processing unit 113 supplies the generated third delay signal P_3 to the noise reduction processing unit 2b.

Based on video signal S_{IN} supplied from the receiver 11 and first delay signal P_1 supplied from the first delay processing unit 111, the detection unit 120b detects a post-scene-change frame from video signal S_{IN}. Then, the detection unit 120b generates scene change detection signal C based on the detected post-scene-change frame.

Specifically, for example, when the post-scene-change frame is detected from video signal S_{IN}, the detection unit 120b sets scene change detection signal C to 1 while video signal S_{IN} indicates a signal for the frame next to the post-scene-change frame and the frame next to the frame next to the post-scene-change frame. In the other period of time, the detection unit 120b sets scene change detection signal C to 0.

The detection unit 120b supplies the generated scene change detection signal C to the noise reduction processing unit 2b.

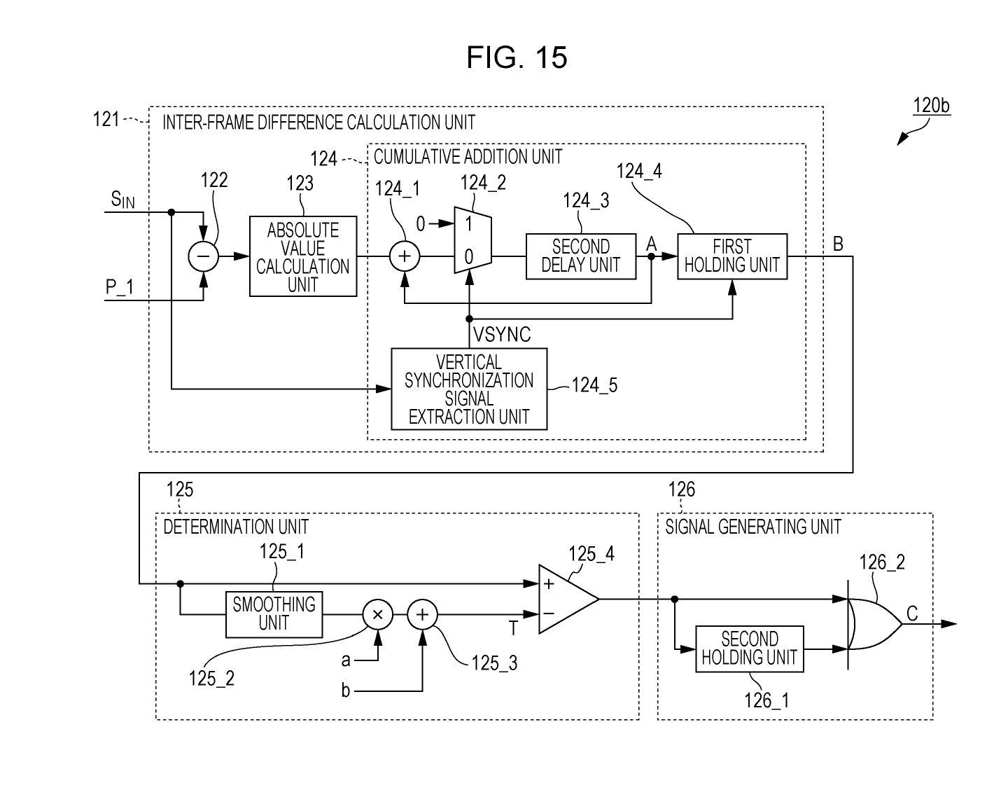

FIG. 15 is a block diagram schematically showing the structure of the detection unit 120b according to the second embodiment. The components common to those in FIG. 5 are given the same reference characters and their descriptions are omitted. In the structure of the detection unit 120b shown in FIG. 15, a signal generating unit 126 has been added to the detection unit 120 shown in FIG. 5.

The signal generating unit 126 generates scene change detection signal C for indicating whether a scene change has been done based on a determination result signal supplied from the determination unit 125. The signal generating unit 126 supplies the generated scene change detection signal C to the noise reduction processing unit 2b. The signal generating unit 126 includes a second holding unit 126_1 and an OR circuit 126_2.

The second holding unit 126_1 holds the determination result signal supplied from the determination unit 125 for the time equivalent to one frame. Then, the second holding unit 126_1 supplies the held determination result signal to the OR circuit 126_2 as the determination result signal as of one frame ago each time the time equivalent to one frame elapses. The second holding unit 126_1 is a D-type flip-flop, for example.

When either the determination result signal as of one frame ago supplied from the second holding unit 126_1 or the determination result signal supplied from the determination unit 125 indicates 1, the OR circuit 126_2 sets scene change detection signal C to 1. In contrast, when both the determination result signal as of one frame ago supplied from the second holding unit 126_1 and the determination result signal supplied from the determination unit 125 indicate 0, the OR circuit 126_2 sets scene change detection signal C to 0.

This allows the signal generating unit 126 to generate scene change detection signal C with a value of 1 in a frame next to the frame immediately after the scene change and the frame two frames behind the frame immediately after the scene change when detecting the frame immediately after the scene change.

The signal generating unit 126 supplies the generated scene change detection signal C to the noise reduction processing unit 2b.

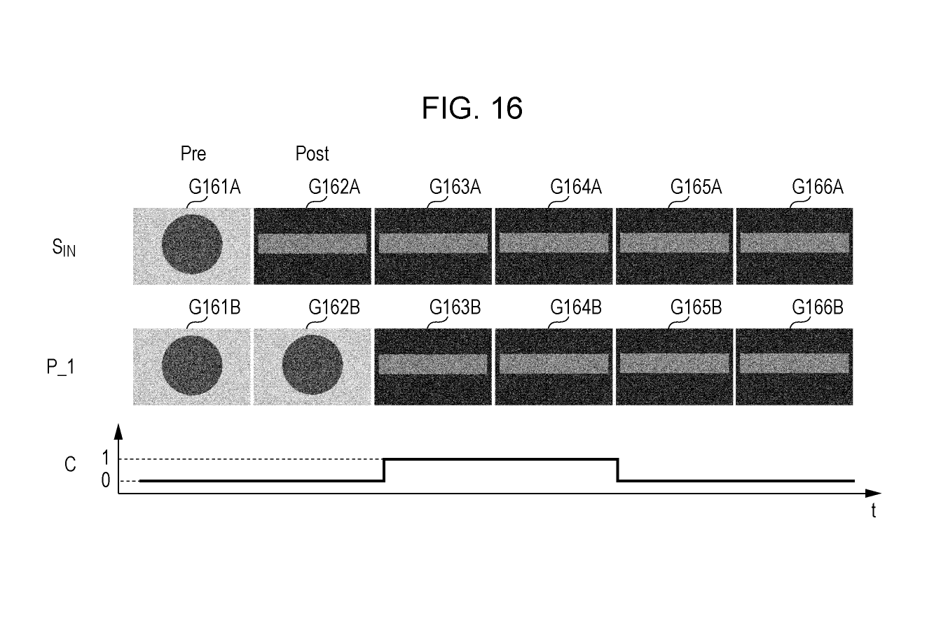

FIG. 16 is a diagram describing generation processing of scene change detection signal C according to the second embodiment. In FIG. 16, on the first line, frame images G161A to G166A indicated by video signal S_{IN} are arranged from left to right in order of appearance. On the second line, frame images G161B to G166B indicated by first delay signal P_1 are arranged from left to right in order of appearance. On the third line, time variations of scene change detection signal C are indicated when video signal S_{IN} on the first line and delay signal P_1 on the second line are provided. In the graph on the third line, the vertical axis represents scene change detection signal C and the horizontal axis represents time t. In the upper/lower direction of FIG. 16, the images at the same hour are arranged.

In FIG. 16, the images of the frames included in first delay signal P_1 are one frame behind the images of the frames included in video signal S_{IN}. Specifically, image G162B is image G161A and image G163B is image G162A. In addition, image G164B is image G163A, image G165B is image G164A, and image G166B is image G165A.

It is also found that, when the image indicated by video signal S_{IN} is an image signal that indicates image G163A or an image signal that indicates image G164A, scene change detection signal C becomes 1. Otherwise, scene change detection signal C becomes 0.

In the images of the frames included in video signal S_{IN}, image G161 is a pre-image immediately before a scene change is made and image G162 is a post-image immediately after a scene change is made.

The detection unit 120b determines that a scene change has been done in the frame of image G162A included in video signal S_{IN} based on a signal indicating image G162A of video signal S_{IN} and a signal indicating image G162B of first delay signal P_1.

Then, the detection unit 120b changes the value indicated by scene change detection signal C from 0 to 1 immediately before video signal S_{IN} indicates the image signal of image G163A. Next, the detection unit 120b changes the value indicated by scene change detection signal C from 1 to 0 immediately before video signal S_{IN} indicates the image signal of image G1645.

That is, the detection unit 120b sets the value indicated by scene change detection signal C to 1 when video signal S_{IN} indicates the image signal of a frame next to a frame immediately after a scene change and the image signal of the frame two frames behind the frame immediately after the scene change.

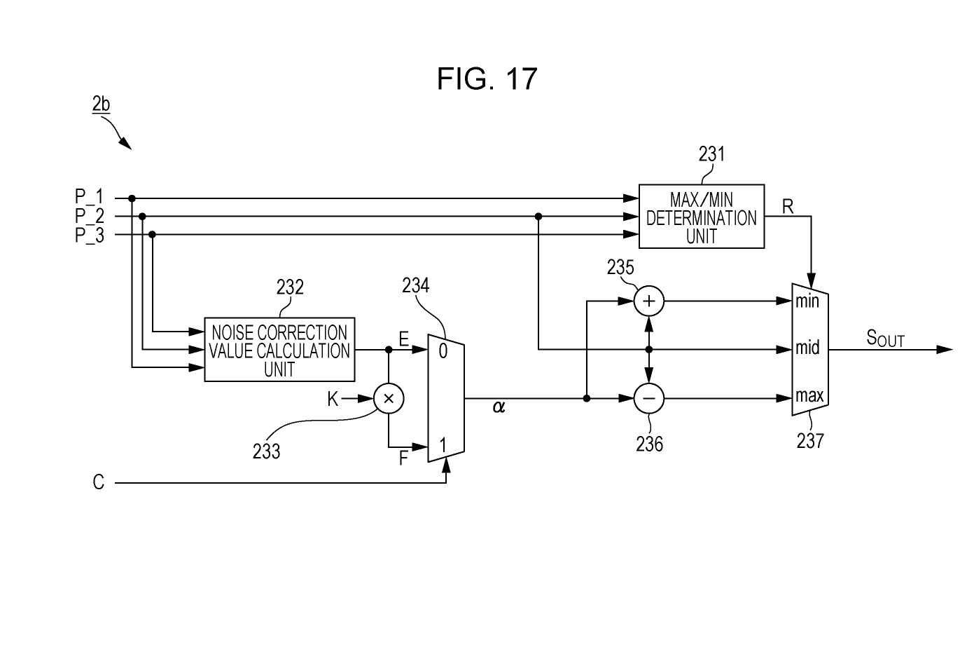

FIG. 17 is a block diagram schematically showing the structure of the noise reduction processing unit 2b according to the second embodiment. The noise reduction processing unit 2b includes a MAX/MIN determination unit 231, a noise correction value calculation unit 232, a second multiplication unit 233, a second multiplication unit 233, a first selection unit 234, a third addition unit 235, a subtraction unit 236, and a second selection unit 237.

The noise reduction processing unit 2b weakens noise reduction of inter-frame noise for the second delay signal in a frame corresponding to a post-scene-change frame detected by the detection unit 120b.

In addition, the noise reduction processing unit 2b reduces inter-frame noise for the second delay signals in frames corresponding to the frames other than a post-scene-change frame detected by the detection unit 120b, based on the first delay signal, the second delay signal, and the third delay signal.

The MAX/MIN determination unit 231 determines whether second delay signal P_2 is the maximum or minimum among first to third delay signals P_1 to P_3. Then, the MAX/MIN determination unit 231 generates determination result signal R indicating the determination result. Specifically, for example, the MAX/MIN determination unit 231 uses a 2-bit determination result signal to output “01” for the minimum value, “10” for the maximum value, or “00” for the middle value.

The MAX/MIN determination unit 231 supplies generated determination result signal R to the second selection unit 237.

The noise correction value calculation unit 232 estimates the standard deviation value of noise (referred to below as the noise standard deviation value) based on the first to third delay signals P_1 to P_3 by assuming the noise of an image to be normally distributed. Specifically, for example, the noise correction value calculation unit 232 estimates the noise standard deviation value using the following processing.

When second delay signal P_2 is the maximum or minimum among first to third delay signals P_1 to P_3, the noise correction value calculation unit 232 calculates the difference |P_2−(P_1+P_3)/2| and increments the frequency of the calculated difference by 1. The noise correction value calculation unit 232 performs the above processing for all pixels of the same frame. The noise correction value calculation unit 232 extracts the difference (most frequent value) that gives the maximum frequency and sets the most frequent value as the noise standard deviation value.

The noise correction value calculation unit 232 supplies standard deviation signal E indicating the estimated noise standard deviation value to the second multiplication unit 233 and the first selection unit 234.

The second multiplication unit 233 multiplies standard deviation signal E supplied from the noise correction value calculation unit 232 by predetermined constant K (number not less than 0 and less than 1) and supplies K-fold signal F obtained through the multiplication to the first selection unit 234.

The first selection unit 234 selects either standard deviation signal E supplied from the noise correction value calculation unit 232 or K-fold signal F supplied from the second multiplication unit 233 based on scene change detection signal C supplied from the detection unit 120b. Specifically, for example, when scene change detection signal C indicates 1, the first selection unit 234 selects K-fold signal F. When scene change detection signal C indicates 0, the first selection unit 234 selects standard deviation signal E.

The first selection unit 234 supplies the selected signal to the third addition unit 235 and the subtraction unit 236 as noise correction signal α.

This allows the first selection unit 234 to reduce noise using a second selection unit described later since the noise standard deviation value is selected as a noise correction value for a frame other than the frames before and after a scene change.

On the other hand, since the first selection unit 234 selects K-fold signal F for one of the frames before and after a scene change, it is possible to prevent the images of the frames before and after a scene change from transferring to each other when noise reduction is performed by the second selection unit described later. Transfer of the image of a frame to the image of another frame means that the image of a frame immediately after a scene change transfers to the image of a frame immediately before a scene change or the image of a frame immediately before a scene change transfers to the image of a frame immediately after a scene change.

The third addition unit 235 adds noise correction signal α to second delay signal P_2 and supplies the addition signal obtained through the addition to the second selection unit 237.

The subtraction unit 236 subtracts noise correction signal α from second delay signal P_2 and supplies the subtraction signal obtained through the subtraction to the second selection unit 237.

The second selection unit 237 selects either the addition signal supplied from second delay signal P_2 and the third addition unit 235 or the subtraction signal supplied from the subtraction unit 236 based on determination result signal R supplied from the MAX/MIN determination unit 231.

Specifically, for example, when determination result signal R indicates the minimum value, the second selection unit 237 selects the addition signal. In contrast, when determination result signal R indicates, for example, the middle value, the second selection unit 237 selects second delay signal P_2. When determination result signal R indicates, for example, the maximum value, the second selection unit 237 selects the subtraction signal.

The second selection unit 237 makes an outstanding pixel value caused by noise close to surrounding pixel values, resulting in reduction of noise included in the image.

The second selection unit 237 supplies the selected signal as noise reduction signal S_{OUT} to the image adjustment unit 13.

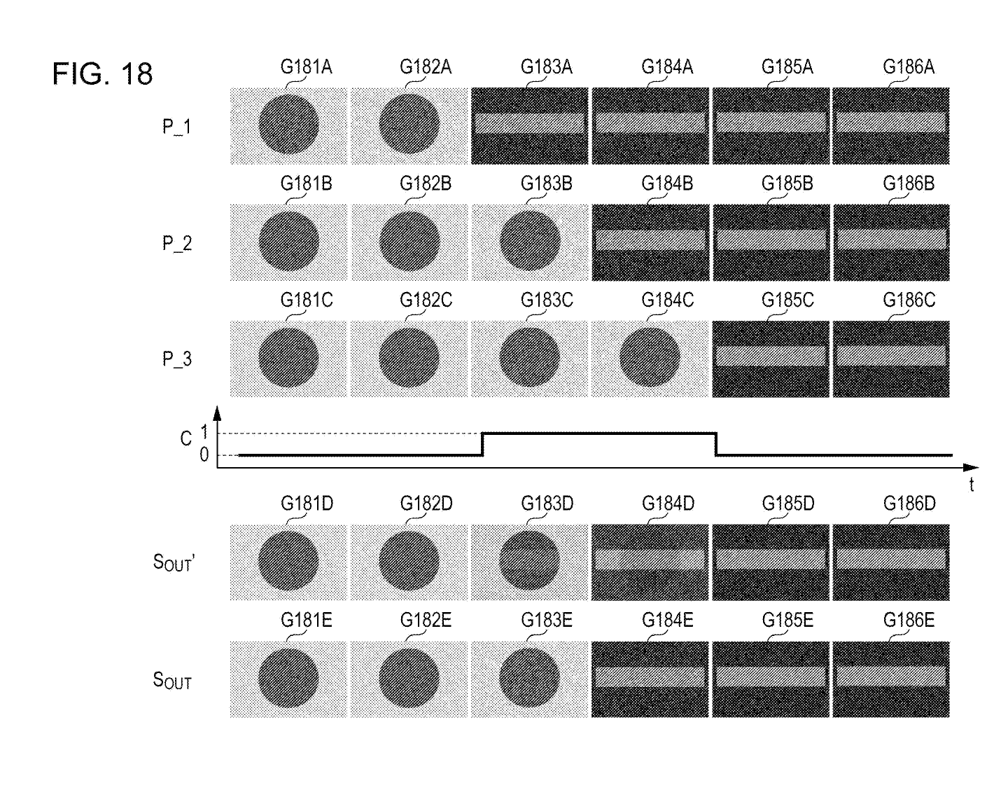

Referring to FIG. 18, processing by the noise reduction processing unit 2b according to the second embodiment will be described when video signal S_{IN} indicates the image shown in FIG. 16. FIG. 18 is a diagram for describing processing by the noise reduction processing unit 2b according to the second embodiment. In FIG. 18, on the first line, images G181A to G186A indicated by first delay signal P_1 are arranged from left to right in order of appearance. On the second line, images G181B to G186B indicated by second delay signal P_2 are arranged from left to right in order of appearance. On the third line, images G181C to G186C indicated by third delay signal P_3 are arranged from left to right in order of appearance.

On the fourth line, time variations of scene change detection signal C are indicated. In the graph on the fourth line, the vertical axis represents scene change detection signal C and the horizontal axis represents time t. On the fifth line, images G181D to G186D of the frames indicated by noise reduction signal S_{OUT}′ in a case where a scene change is not detected are arranged from left to right in order of appearance. On the sixth line, images G181E to G186E of the frames indicated by noise reduction signal S_{OUT} according to the present embodiment are arranged from left to right in order of appearance. In the upper/lower direction of FIG. 18, the images at the same hour are arranged.

In FIG. 18, the images indicated by second delay signal P_2 are one frame behind the images indicated by first delay signal P_1. In addition, the images indicated by third delay signal P_3 are one frame behind the images indicated by second delay signal P_2.

On the fifth line, the pixel values of an image indicated by noise reduction signal S_{OUT}′ in a case where a scene change is not detected is causally related to the pixel values of pixels included in an image indicated by first delay signal P_1, the pixel values of pixels at the positions equivalent to the pixels in an image indicated by second delay signal P_2, and the pixel values of pixels at the positions equivalent to the pixels in an image indicated by third delay signal P_3. Accordingly, in image G183D in FIG. 18, an afterimage of image G183A of first delay signal P_1 remains on image G183B of second delay signal P_2. In addition, in image G184D in FIG. 18, an afterimage of image G184C of third delay signal P_3 remains on image G184B of second delay signal P_2.

Image G183E or G184E indicated by noise reduction signal S_{OUT} on the sixth line in a case where the scene change detection signal is 1 is the image indicated by second delay signal P_2. The image indicated by noise reduction signal S_{OUT} on the sixth line in a case where the scene change detection signal is 0 is the image that has been subject to noise reduction by the second selection unit.

As a result, the noise reduction processing unit 2b weakens the noise reduction of inter-frame noise included in the images of frames before and after the scene change, thereby preventing an afterimage of the image before or after the scene change from remaining on the image indicated by scene change noise reduction signal S_{OUT}.

Since a flow of processing by a display apparatus 10b according to the second embodiment is the same as that by the display apparatus 10a according to the first embodiment shown in FIG. 9, its description is omitted.

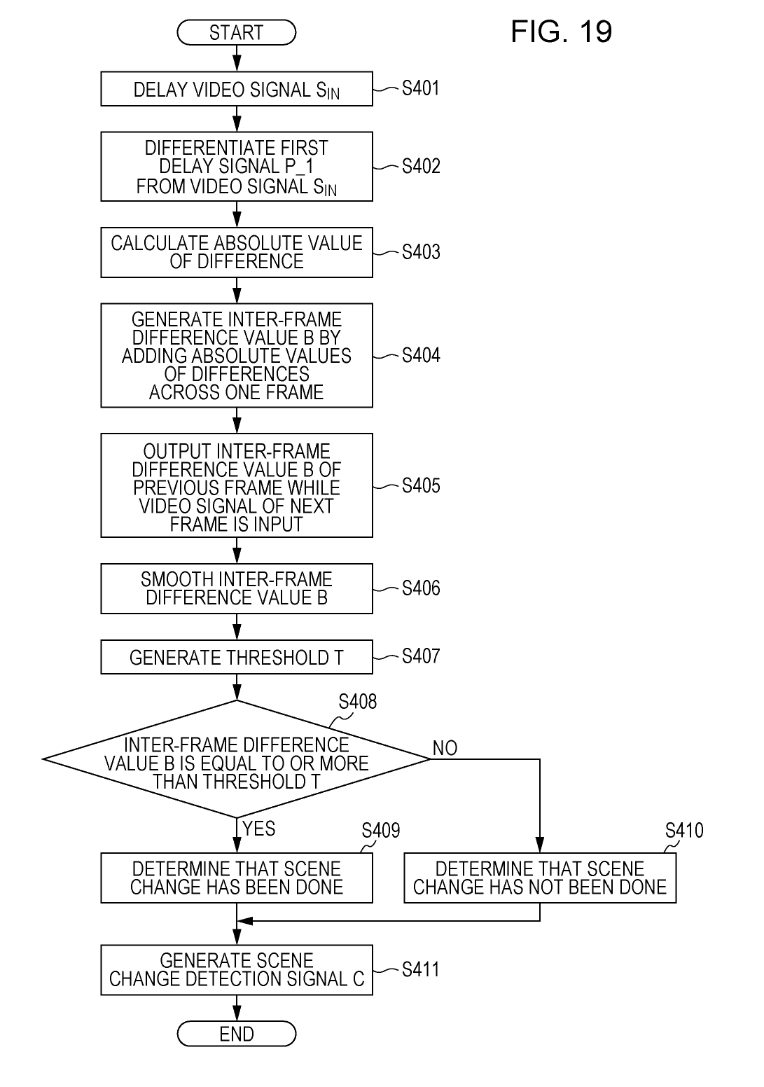

FIG. 19 is an example of a flowchart showing a flow of scene change detection processing by the scene change frame detection unit 1b according to the second embodiment. Since the processing from step S401 to step S410 is the same as that of step S201 to step S210, their descriptions are omitted. In step S411, the signal generating unit 126 generates scene change detection signal C based on determination results by the determination unit 125 (step S411). Now, the processing of this flowchart is completed.

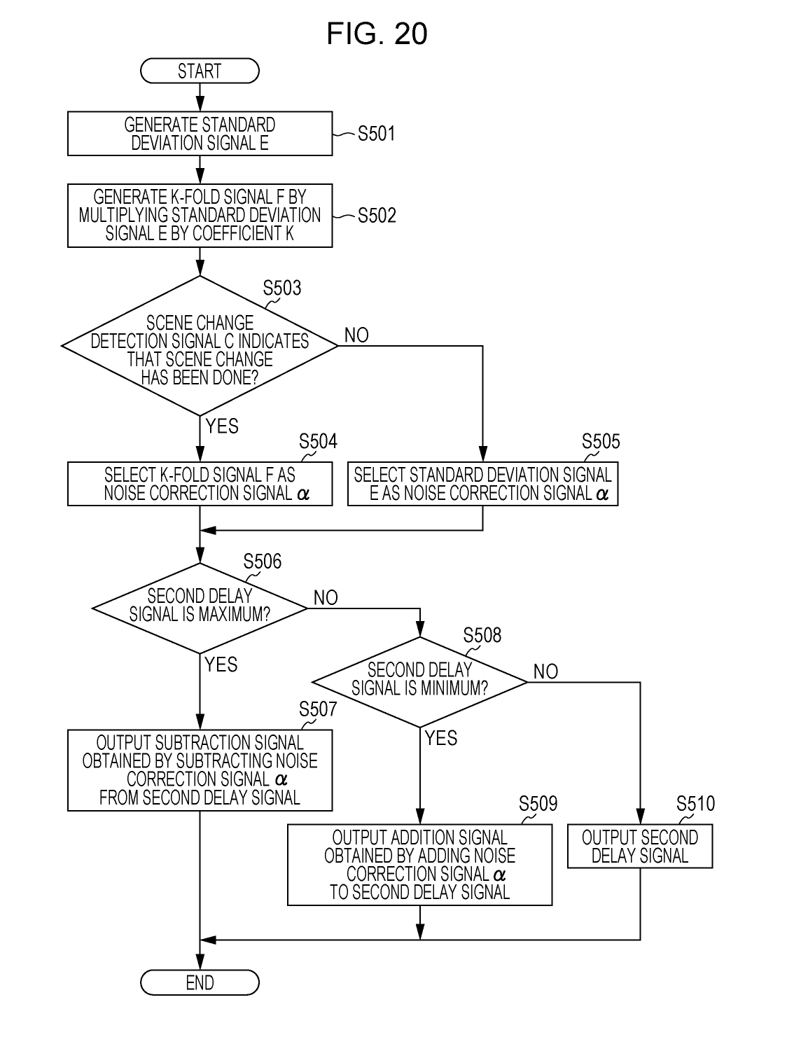

FIG. 20 shows an example of a flowchart showing a flow of processing by the noise reduction processing unit 2b according to the second embodiment. First, the noise correction value calculation unit 232 generates standard deviation signal E (step S501). Next, the second multiplication unit 233 generates a K-fold signal by multiplying standard deviation signal E by coefficient K (step S502). Next, the first selection unit 234 determines whether scene change detection signal K indicates the occurrence of a scene change (step S503).

When scene change detection signal K indicates that a scene change has been done (YES in step S503), the first selection unit 234 selects K-fold signal F as noise correction signal α (step S504).

In contrast, when scene change detection signal K indicates that a scene change has not been done (NO in step S503), the first selection unit 234 selects standard deviation signal E as noise correction signal α (step S505).

Next, the second selection unit 237 determines whether the second delay signal is maximum (step S506). When the second delay signal is maximum (YES in step S506), the second selection unit 237 outputs a subtraction signal obtained by subtracting noise correction signal α from the second delay signal (step S507).

In contrast, when the second delay signal is not maximum (NO in step S506), the second selection unit 237 determines whether the second delay signal is minimum (step S508). When the second delay signal is minimum (YES in step S508), the second selection unit 237 outputs an addition signal obtained by adding noise correction signal α to the second delay signal (step S509). In contrast, when the second delay signal is not minimum (NO in step S508), the second selection unit 237 outputs the second delay signal (step S510).

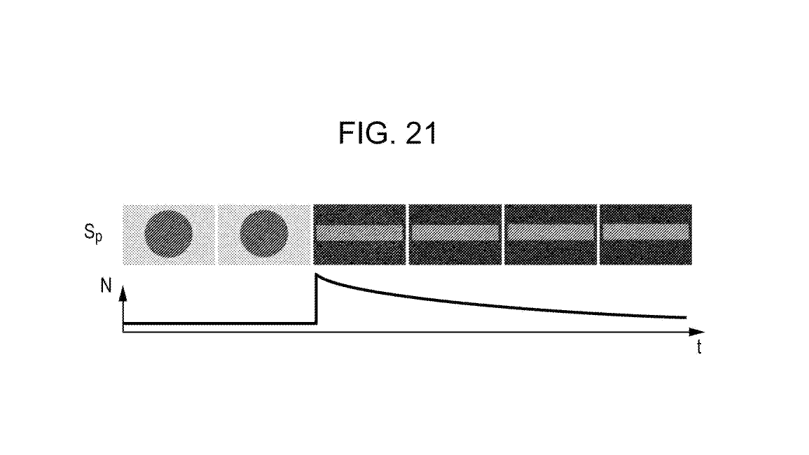

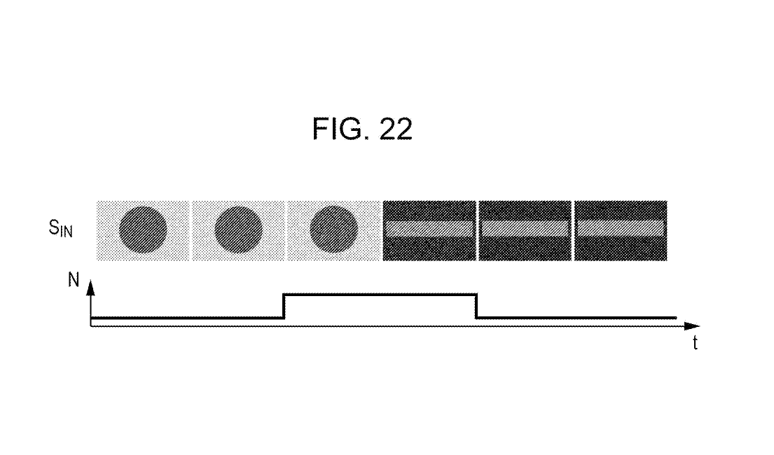

Noise reduction effects of a noise reduction unit 12b according to the present embodiment will be described with reference to FIGS. 21 and 22. FIG. 21 is a diagram showing time variations of the amount of noise when using a conventional cyclic noise reduction apparatus described in PTL 1. On the first line of FIG. 21, the images of frames included in video signal SP are arranged from left to right in order of appearance. On the second line, time variations of amount N of noise when the images on the first line are given. In the graph on the second line, the vertical axis represents amount N of noise and the horizontal axis represents time t. In the graph, the amount of noise peaks immediately after a scene change and reduces gradually. As described above, in a conventional cyclic noise reduction apparatus, noise remains in many frames after a scene change has been done.

FIG. 22 is a diagram showing time variations of the amount of noise when using the noise reduction unit 12b according to this embodiment. In the graph on the second line, the vertical axis represents amount N of noise and the horizontal axis represents time t. On the first line of FIG. 22, as in FIG. 21, the images of frames included in video signal S_{IN} are arranged from left to right in order of appearance. On the second line, time variations of amount N of noise when the images on the first line are given. On the second line, much noise is present in the frames before and after a scene change and less noise is present in other frames. As described above, the frames including much noise are limited to the ones before and after a scene change in the noise reduction unit 12b according to the present embodiment, and more noise can be reduced in frames after the frame immediately after a scene change than in the frame immediately after a scene change.

Based on the video signal and the first delay signal obtained by delaying the video signal by the predetermined first number of frames, the noise reduction unit 12b detects the frames immediately before and immediately after a scene change, from the video signal. For the image signals of the frames immediately before and immediately after a change of a detected scene, the noise reduction unit 12b weakens noise reduction of inter-frame noise superimposed between the frames. This enables the noise reduction unit 12b to prevent the video immediately after a scene change and the video immediately before a scene change from remaining as afterimages on the video immediately before a scene change and the video immediately after a scene change, respectively.

For frames other than the ones immediately before and immediately after a scene change, the noise reduction unit 12b reduces inter-frame noise superimposed between the frames. Accordingly, the noise reduction unit 12b can reduce noise in frames other than the ones immediately before and immediately after a scene change.

As described above, the noise reduction unit 12b prevents noise being superimposed on the image for a long period of time after the scene change while preventing an afterimage from remaining on the image before and after the scene change. As a result, the noise reduction unit 12b can provide video easily viewable to audiences.

### <Modification of the Determination Unit>

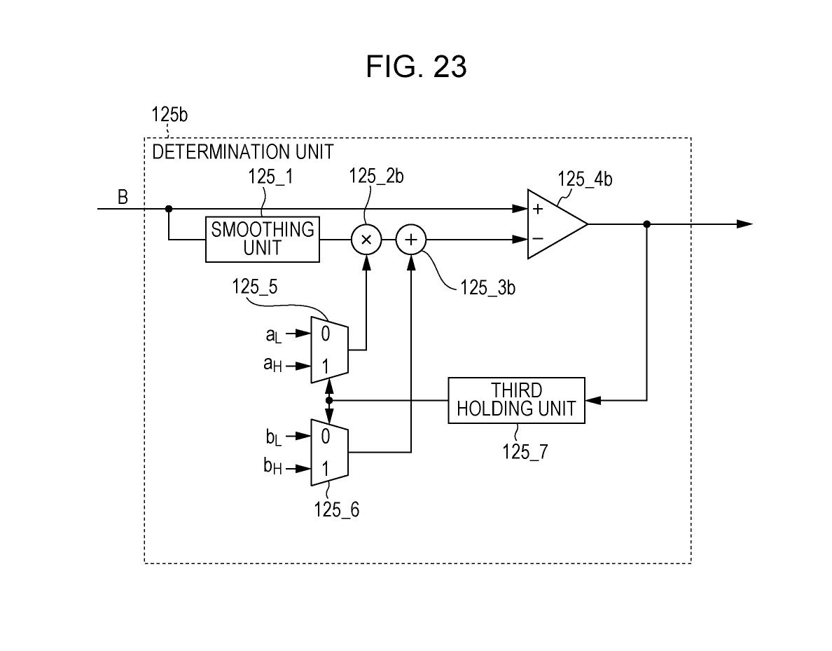

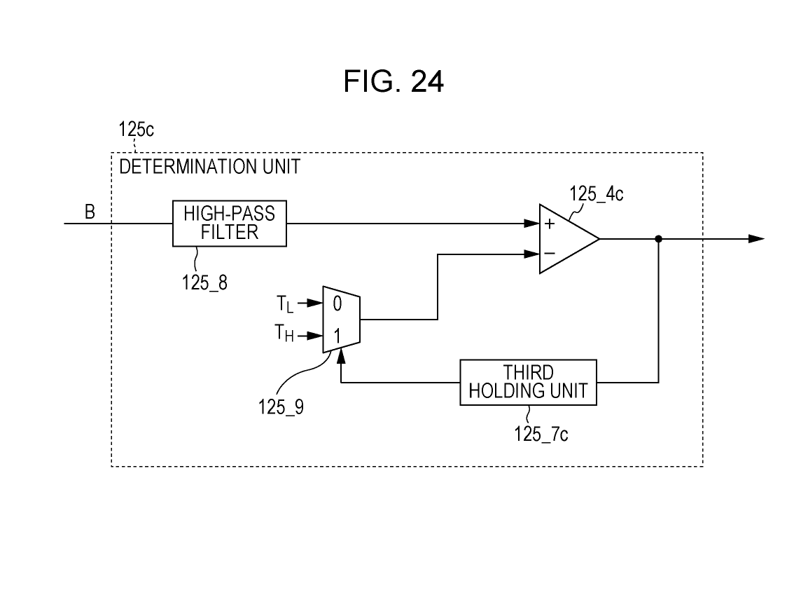

A modification of the determination unit according to the present embodiment will be described with reference to FIGS. 23 and 24. FIG. 23 is a block diagram schematically showing the structure of a determination unit 125b according to a first modification. The components common to those in FIG. 15 are given the same reference characters and their descriptions are omitted. In the structure of the determination unit 125b shown in FIG. 23, the first multiplication unit 125_2 has been changed to the first multiplication unit 125_2b, the second addition unit 125_3 has been changed to the second addition unit 125_3b, the comparison unit 125_4 has been changed to the comparison unit 125_4b, and a third selection unit 125_5, a fourth selection unit 125_6, and the third holding unit 125_7 have been added.

The third selection unit 125_5 receives, from the third holding unit 125_7, a determination result signal of the result of determination made by the comparison unit 125_4b indicating whether a scene change has been done for the previous frame. The third selection unit 125_5 selects either first slope signal aL indicating a first slope or second slope signal aH indicating a second slope, which is equal to or more than the first slope, based on the determination result supplied from the third holding unit 125_7.

Specifically, for example, when the determination result signal indicates that a scene change has not been done for the previous frame (for example, the determination result signal is 0), the third selection unit 125_5 selects the first slope signal aL. In contrast, when the determination result signal indicates that a scene change has been done for the previous frame (for example, the determination result signal is 1), the third selection unit 125_5 selects the second slope signal aH.

The third selection unit 125_5 supplies the selected signal to the first multiplication unit 125_2b.

The fourth selection unit 125_6 receives, from the third holding unit 125_7, a determination result signal of the result of determination made by the comparison unit 125_4b indicating whether a scene change has been done for the previous frame. Then, the fourth selection unit 125_6 selects either first intercept signal bL indicating a first intercept or second intercept signal bH indicating a second intercept, which is equal to or more than the first intercept, based on the determination result signal supplied from the third holding unit 125_7.

Specifically, for example, when the determination result signal indicates that a scene change has not been done for the previous frame (for example, the determination result signal is 0), the fourth selection unit 125_6 selects the first intercept signal bL. In contrast, when the determination result signal indicates that a scene change has been done for the previous frame (for example, the determination result signal is 1), the fourth selection unit 125_6 selects the second intercept signal bH.

The fourth selection unit 125_6 supplies the selected signal to the second addition unit 125_3b.

The first multiplication unit 125_2b multiplies smoothing signal Sm supplied from the smoothing unit 125_1 by the signal supplied from the third selection unit 125_5, and supplies a multiplication signal obtained by the multiplication to the second addition unit 125_3b.

The second addition unit 125_3b adds the signal supplied from the fourth selection unit 125_6 to the multiplication signal supplied from the first multiplication unit 125_2b, and supplies threshold signal T supplied through the addition to the comparison unit 125_4b.

When inter-frame difference signal B supplied from the inter-frame difference calculation unit 121 is equal to or more than threshold T supplied from the second addition unit 125_3b, the comparison unit 125_4b sets the determination result to 1. In contrast, when inter-frame difference signal B supplied from the inter-frame difference calculation unit 121 is less than the threshold supplied from the second addition unit 125_3b, the comparison unit 125_4b sets the determination result to 0.

The comparison unit 125_4b supplies the set determination signal to the third holding unit 125_7 and the signal generating unit 126.

The third holding unit 125_7 captures the determination result signal supplied from the comparison unit 125_4b at the leading edge of the clock signal (not shown) and supplies the captured determination result signal to the third selection unit 125_5 and the fourth selection unit 125_6.

Then, the third holding unit 125_7 supplies the captured determination result signal to the third selection unit 125_5 and the fourth selection unit 125_6 until the leading edge of the next clock signal. The third holding unit 125_7 is a D-type flip-flop, for example.

With this, the third holding unit 125_7 supplies the determination result signal for the target frame to be determined to the third selection unit 125_5 and the fourth selection unit 125_6 when threshold signal T for the frame next to the target frame is generated.

As a result, when the determination result signal of the target frame is 0, that is, a scene change has not been done in the target frame, the determination unit 125b selects coefficient signals aL and bL in the frame next to the target frame. Then, the determination unit 125b generates lower threshold TL as the threshold signal by multiplying smoothing signal Sm by coefficient signal aL and adding coefficient signal bL to the multiplication result. This causes the determination unit 125b to set threshold signal T of the frame next to the target frame to lower threshold signal TL.

In contrast, when the determination result signal of the target frame is 1, that is, a scene change has been done in the target frame, the determination unit 125b selects coefficient signals aH and bH in the frame next to the target frame. Then, the determination unit 125b generates, as the threshold signal, upper threshold signal TH obtained by multiplying smoothing signal Sm by coefficient signal aH and adding coefficient signal bH to the multiplication result. This allows the determination unit 125b to make threshold signal T of the frame next to the target frame larger than threshold signal T of the target frame.

As a result, even if panning for changing the orientation of a fixed camera starts from the frame next to a frame immediately after a scene change, the determination unit 125b can determine that no scene change has been done because threshold signal T is large. This prevents the determination unit 125b from erroneously detecting panning as a scene change, thereby correctly determining whether a scene change has been done.

FIG. 24 is a block diagram schematically showing the structure of a determination unit 125c according to a second modification. The components common to those in FIG. 15 are given the same reference characters and their descriptions are omitted. The determination unit 125c includes a comparison unit 125_4c, a third holding unit 125_7c, a high-pass filter 125_8, and a fifth selection unit 125_9.

The high-pass filter 125_8 generates a high-pass filtered signal by passing the high-frequency components equal to or more than a predetermined cut-off frequency from inter-frame difference signal B supplied from the inter-frame difference calculation unit 121, and supplies the generated high-pass filtered signal to the comparison unit 125_4c.

The fifth selection unit 125_9 selects either lower threshold signal TL or upper threshold signal TH based on the determination result signal supplied from the third holding unit 125_7c.

Specifically, for example, when the determination result signal indicates a scene change, the fifth selection unit 125_9 selects upper threshold signal TH. In contrast, when the determination result signal does not indicate a scene change, the fifth selection unit 125_9 selects lower threshold signal TL.

The fifth selection unit 125_9 supplies the selected signal as threshold signal T to the comparison unit 125_4c.

When the high-pass filtered signal supplied from the high-pass filter 125_8 is equal to or more than threshold signal T supplied from the fifth selection unit 125_9, the comparison unit 125_4c determines that a scene change has been done in the target frame and sets the determination result signal to 1.

In contrast, when the high-pass filtered signal supplied from the high-pass filter 125_8 is less than threshold signal T supplied from the fifth selection unit 125_9, the comparison unit 125_4c determines that a scene change has not been done in the target frame and sets the determination result signal to 0.

The comparison unit 125_4c supplies the set determination result signal to the third holding unit 125_7c.

As in the third holding unit 125_7 in FIG. 23, the third holding unit 125_7c captures the determination result signal supplied from the comparison unit 125_4c at the leading edge of the clock signal (not shown) and supplies the captured determination result signal to the fifth selection unit 125_9.

Then, the third holding unit 125_7c supplies the captured determination result signal to the fifth selection unit 125_9 until the leading edge of the next clock signal. The third holding unit 125_7c is a D-type flip-flop, for example.

With this, the third holding unit 125_7c supplies the determination result signal for the target frame to be determined to the fifth selection unit 125_9 when threshold signal T for the frame next to the target frame is generated.

When the determination result signal of the target frame is 1, that is, a scene change has been done in the target frame, the determination unit 125c selects upper threshold signal TH in the frame next to the target frame. This allows the determination unit 125c to make threshold signal T of the frame next to the target frame larger than threshold signal T of the target frame.

As a result, even if panning starts from the frame next to a frame immediately after a scene change, the determination unit 125c can determine that no scene change has been done because threshold signal T is large. This prevents the determination unit 125c from erroneously detecting panning as a scene change, thereby correctly determining whether a scene change has been done.

### <Modification of the Noise Reduction Unit>

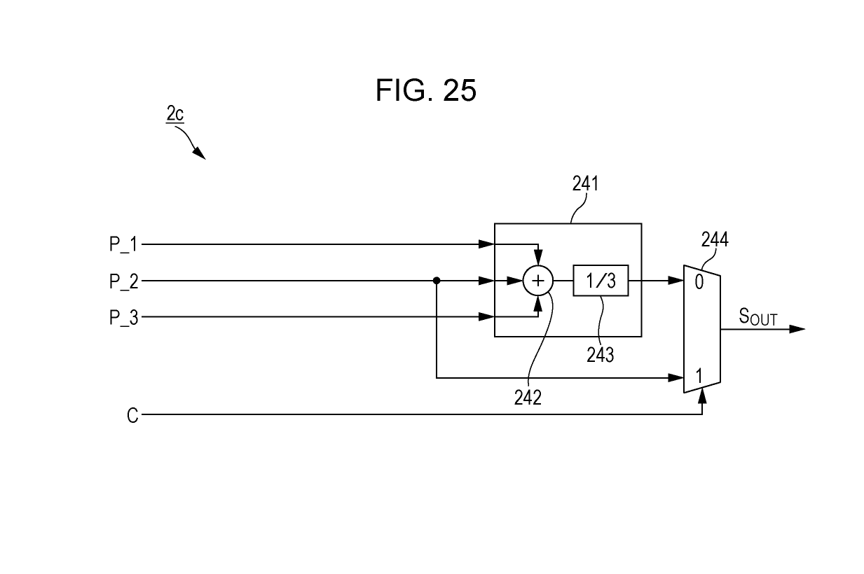

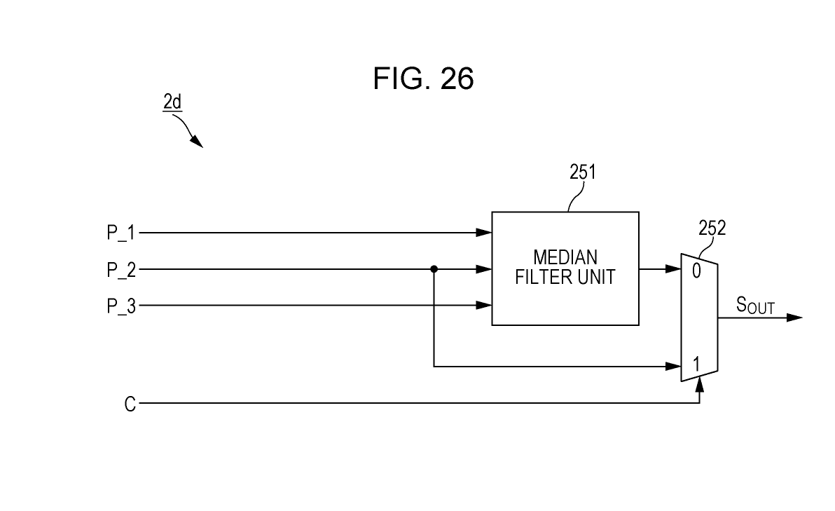

A modification of the noise reduction unit will be described with reference to FIGS. 25 and 26. FIG. 25 is a block diagram schematically showing the structure of a noise reduction processing unit 2c according to the first modification. The noise reduction processing unit 2c includes an averaging unit 241 and a sixth selection unit 244.

The averaging unit 241 averages the first to third delay signals P_1 to P_3 supplied from the scene change frame detection unit 1b and supplies the averaged average signal to the sixth selection unit 244. The averaging unit 241 is a type of a low-pass filter. The averaging unit 241 includes a summation calculation unit 242 and a division unit 243.

The summation unit 242 generates a summation signal indicating the summation of first to third delay signals P_1 to P_3 supplied from the scene change frame detection unit 1b and supplies the generated summation signal to the division unit 243.

The division unit 243 divides the summation signal supplied from the summation unit 242 by 3 and supplies the divided signal as the average signal described above to the sixth selection unit 244.

When scene change detection signal C indicates that a scene change has been done, the sixth selection unit 244 supplies second delay signal P_2 supplied from the scene change frame detection unit 1b to the image adjustment unit 13 as is, as noise reduction signal S_{OUT}.

In contrast, when scene change detection signal C indicates that a scene change has not been done, the sixth selection unit supplies the average signal supplied from the averaging unit 241 to the image adjustment unit 13 as noise reduction signal S_{OUT}.

Accordingly, when scene change detection signal C indicates that a scene change has not been done, the noise reduction processing unit 2c suppresses high-frequency components including much noise is present by averaging first to third delay signals P_1 to P_3, thereby reducing visual noise.

In contrast, when scene change detection signal C indicates that a scene change has been done, noise is not reduced in the averaging unit 241. Since the section in which noise is not reduced is at most two frames in length and human eyes do not easily perceive noise, visual noise is not increased even if noise is included in the two-frame image.

The frames referenced by the noise reduction processing unit 2c in the first modification for noise reduction are the frame indicated by second delay signal P_2, used as the reference, the frame of first delay signal P_1, and the frame of third delay signal P_3. Accordingly, noise reduction signal S_{OUT} output from the noise reduction processing unit 2c is not affected by a frame other than these three frames in principle.

That is, in a conventional cyclic noise reduction apparatus, noise that is based on noise superimposed on a frame immediately after a scene change is superimposed on noise-reduced signal in many frames behind a scene change.

On the other hand, since the noise reduction processing unit 2c in the first modification references finite frames, noise that is based on noise superimposed on a frame immediately after a scene change is not superimposed on noise reduction signal S_{OUT} in frames behind a frame immediately after a scene change, the amount of noise becomes lower than in a conventional cyclic noise reduction apparatus.

FIG. 26 is a block diagram schematically showing the structure of a noise reduction processing unit 2d according to the second modification. The noise reduction processing unit 2d includes a median filter unit 251 and a seventh selection unit 252.

The median filter unit 251 applies a median filter to the first to third delay signals P_1 to P_3 supplied from the scene change frame detection unit 1b and generates a median-filtered signal. The median filter unit 251 supplies the median-filtered signal generated to the seventh selection unit.

The seventh selection unit selects either the median-filtered signal or second delay signal P_2 based on scene change detection signal C supplied from the scene change frame detection unit lb. Specifically, for example, when scene change detection signal C indicates that a scene change has been done (for example, scene change detection signal C indicates 1), the seventh selection unit selects second delay signal P_2. In contrast, when scene change detection signal C indicates that a scene change has not been done (for example, scene change detection signal C indicates 0), the seventh selection unit selects the median-filtered signal.

The seventh selection unit supplies the selected signal as noise reduction signal S_{OUT} to the image adjustment unit 13.

The noise reduction processing unit 2d according to the present embodiment uses a median filter, but another filter may be used as long as it can reduce noise.

The scene change frame detection units 1 and 1b according to the embodiments detect post-scene-change frame immediately after a scene change from video signal S_{IN} based on video signal S_{IN} and a delay signal obtained by delaying video signal S_{IN} by a predetermined first number of frames, but this is not restrictive.

The scene change frame detection units 1 and 1b according to the embodiments may detect a frame immediately before or immediately after a scene change among the frames included in video signal S_{IN} or the first delay signal based on video signal S_{IN} and the delay signal a predetermined first number of frames behind video signal S_{IN}.

In this case, the noise reduction processing unit 2 or 2b only needs to weaken noise reduction of inter-frame noise superimposed between frames for the image signal of a frame immediately before or immediately after a scene change detected by the scene switching frame detection unit.

The scene change frame detection units 1 and 1b according to the embodiments may detect a frame immediately before or immediately after a scene change among the frames included in video signal S_{IN} or an early signal based on video signal S_{IN} and the early signal obtained by advancing video signal S_{IN}.

The delay signal or early signal is an example of a time-difference signal having a time-difference from video signal S_{IN}.

In terms of this, the scene change frame detection units 1 and 1b according to the embodiments may detect a frame immediately before or immediately after a scene change among the frames included in video signal S_{IN} or the time-difference signal, based on video signal S_{IN} and the time-difference signal.

In this case, the noise reduction processing unit 2 or 2b only needs to weaken noise reduction of inter-frame noise superimposed between frames for the image signal of a frame immediately before or immediately after a scene change detected by the scene switching frame detection unit 1 or 1b.

In addition, the scene change frame detection units 1 and 1b according to the embodiments may detect at least one of the frames immediately before and immediately after a scene change among the frames included in video signal S_{IN} or the time-difference signal, based on video signal S_{IN} and the time-difference signal having time-difference from video signal S_{IN}.

In this case, the noise reduction processing unit 2 or 2b only needs to weaken noise reduction of inter-frame noise superimposed between frames for an image signal of at least one of frames immediately before and immediately after a scene change detected by the scene switching frame detection unit 1 or 1b.

In the embodiment, the noise reduction unit 12a or 12b is described as a component of the display apparatus 10a or 10b, but the noise reduction unit 12a or 12b may be implemented as an independent unit.

It is possible to perform various types of processing related to the noise reduction unit 12a or 12b described above by recording a program (noise reduction program) in a computer-readable recording medium and causing a computer system to read and execute the program recorded in this recording medium.

The computer system above may include an operating system and hardware components such as peripheral devices. The computer system may use a WWW system or may include an environment for providing (or displaying) homepages. The computer-readable recording medium refers to writable nonvolatile memory such as a flexible disk, magnetic optical disk, ROM, flash memory, a mobile medium such as a CD-ROM, a storage device such as a hard disk drive incorporated in the computer system.

In addition, the computer-readable recording medium refers to a medium that holds a program for a certain period of time, such as a volatile memory (for example, a dynamic random access memory (RAM)) in the computer system operating as a server or client used when a program is transferred via a network such as the Internet or a communication line such as a phone line. The program may be transmitted from the computer system that stores the program in its storage device etc. to another computer system via a transmission medium or transmitted waves in a transmission medium. The transmission medium through which the program is transmitted is a medium having the function of transmitting information as a communication line such as a network (communication network) such as the Internet or a communication line such as a phone line. The program may achieve a part of the function described above. The program may be a so-called difference file (difference program) achieved by combining the function described above with a program already stored in the computer system.

The embodiments of the present invention have been described with reference to the drawings, but the specific structure is not restricted by the embodiments and design or the like without departing from the scope of the present invention may be included.

### REFERENCE SIGNS LIST

1, 1b scene change frame detection unit
2, 2b noise reduction processing unit
10a, 10b display apparatus
12a, 12b noise reduction unit
13 image adjustment unit
14 timing control unit
15 source driver unit
16 gate driver unit
17 liquid crystal panel unit
20 liquid crystal display unit
110 first delay unit (delay unit)
111 first delay processing unit
112 second delay processing unit
113 third delay processing unit
120, 120b detection unit
121 inter-frame difference calculation unit
122 difference calculation unit
123 absolute value calculation unit
124 cumulative addition unit
124_1 first addition unit
124_2 selection unit
124_3 second delay unit
124_4 first holding unit
125, 125c determination unit
125_1 smoothing unit
125_2, 125_2b first multiplication unit
125_3, 125_3b second addition unit
125_4, 125_4b, 125_4c comparison unit
125_5 third selection unit
125_6 fourth selection unit
125_7, 125_7c third holding unit
125_8 high-pass filter
125_9 fifth selection unit
126 signal generating unit
126_1 second holding unit
126_2 OR circuit
210 average calculation unit
220 switching unit
231 MAX/MIN determination unit
232 noise correction value calculation unit
233 second multiplication unit
234 first selection unit
235 third addition unit
236 subtraction unit
237 second selection unit
241 averaging unit
242 summation calculation unit
243 division unit
244 sixth selection unit
251 median filter unit
252 seventh selection unit

1-13. (canceled)

14. A noise reduction apparatus comprising:
a scene change frame detection unit that references a video signal and a time-difference signal having a time difference from the video signal and detects one of frames immediately before and immediately after a scene change among frames included in the video signal or the time-difference signal; and
a noise reduction processing unit that weakens noise reduction of inter-frame noise superimposed between frames for an image signal the frame detected by the scene change frame detection unit.

15. The noise reduction apparatus according to claim 14, wherein
the time-difference signal is a first delay signal obtained by delaying the video signal,
the scene change frame detection unit detects a post-scene-change frame, which is a frame immediately after a scene change, among frames included in the video signal based on the video signal and the first delay signal, and
the noise reduction processing unit weakens noise reduction of inter-frame noise for an image signal of the post-scene-change frame detected by the scene change frame detection unit.

16. The noise reduction apparatus according to claim 15, wherein
the scene change frame detection unit includes
a delay unit that generates the first delay signal by delaying a video signal by a predetermined first number of frames and
a detection unit that detects the post-scene-change frame among the frames included in the video signal based on the video signal and the time-difference signal generated by the delay unit.

17. The noise reduction apparatus according to claim 16, wherein
the delay unit generates a second delay signal by delaying the video signal by a second number of frames, which is more than the first number of frames and
the noise reduction processing unit weakens noise reduction of inter-frame noise for the second delay signal in a frame corresponding to the post-scene-change frame detected by the detection unit.

18. The noise reduction apparatus according to claim 17, wherein
the noise reduction processing unit reduces the inter-frame noise of the second delay signal based on the first delay signal and the second delay signal for the second delay signal in a frame corresponding to a frame other than the post-scene-change frame detected by the detection unit.

19. The noise reduction apparatus according to claim 17, wherein
the delay unit generates a third delay signal by delaying the video signal by a third number of frames, which is more than the second number of frames, and
the noise reduction processing unit reduces the inter-frame noise based on the first delay signal, the second delay signal, and the third delay signal for the second delay signal in a frame corresponding to a frame other than the post-scene-change frame detected by the detection unit.

20. The noise reduction apparatus according to claim 16, wherein
the detection unit includes
an inter-frame difference calculation unit that calculates an inter-frame difference value, which is a pixel value difference between the video signal and the time-difference signal, for each frame based on the video signal and the time-difference signal and
a determination unit that determines whether a scene change has been done for each frame based on the inter-frame difference value calculated by the inter-frame difference calculation unit for each frame, and
the noise reduction processing unit weakens, when the determination unit determines that a scene change has been done, noise reduction of the inter-frame noise for a frame for which a scene change has been done.

21. The noise reduction apparatus according to claim 20, further comprising:
a signal generation unit that generates, when the determination unit determines that a scene change has been done, a scene change detection signal indicating that a scene change has been done in a target frame for which a scene change has been done and a frame immediately before the target frame, wherein
the noise reduction processing unit weakens noise reduction of the inter-frame noise for a frame for which a scene change has been detected by the scene change detection signal among frames included in the video signal.

22. The noise reduction apparatus according to claim 14, wherein
the time-difference signal is an early signal obtained by advancing the video signal and
the scene change frame detection unit detects a frame immediately before or immediately after a scene change among frames included in the video signal or the early signal based on the video signal and the early signal.

23. A display apparatus including the noise reduction apparatus according to claim 14.

24. A noise reduction method executed by a noise reduction apparatus, the method comprising:
a scene change frame detection process of detecting one of frames immediately before and immediately after a scene change among frames included in a video signal and a time-difference signal having a time difference from the video signal based on the video signal and the time-difference signal, and
a noise reduction process of weakening noise reduction of inter-frame noise superimposes between frames for an image signal of the frame detected by the scene change frame detection process.

25. A noise reduction program causing a computer to execute
a scene change frame detection step that detects one of frames immediately before and immediately after a scene change among frames included in a video signal or a time-difference signal having a time difference from the video signal based on the video signal and the time-difference signal, and
a noise reduction step that weakens noise reduction of inter-frame noise superimposes between frames for an image signal of the frame detected by the scene change frame detection step.
